(19) United States
(12) Patent Application Publication
(10) Pub. No.: US 2025/0048267 A1
(43) Pub. Date: Feb. 6, 2025

(54) PRE-INDICATION FOR HIGH MOBILITY SYSTEMS

(71) Applicant: QUALCOMM Incorporated, San Diego, CA (US)

(72) Inventors: Huilin XU, Temecula, CA (US); Xiao Feng WANG, San Diego, CA (US); Jun MA, San Diego, CA (US)

(21) Appl. No.: 18/363,559

(22) Filed: Aug. 1, 2023

(51) Int. Cl. H04W 52/02; H04W 72/23

(52) U.S. Cl. CPC H04W 52/0235; H04W 72/23

(57) ABSTRACT

Methods, systems, and devices for wireless communication are described. In some systems, a network entity may transmit, to a user equipment (UE) while the UE operates in an active state, a control signal including a request for the UE to transition to an inactive state for at least a time period and including a set of communication parameters for subsequent communications after operating in the inactive state for at least the time period. The active state may be associated with monitoring for a downlink control channel and the inactive state may be associated with skipping monitoring for the downlink control channel. The UE may transition from the active state to the inactive state for at least the time period based on the control signal. The UE may subsequently operate in the active state after the time period in accordance with the set of communication parameters indicated via the control signal.

### FIELD OF TECHNOLOGY

The following relates to wireless communication, including pre-indication for high mobility systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may operate in a discontinuous reception (DRX) mode, in which the UE may transition between a DRX active state and a DRX inactive state in accordance with a DRX periodicity. The UE may monitor for a downlink control channel while operating in the DRX active state and may refrain from or skip monitoring the downlink control channel while operating in the DRX inactive state.

### SUMMARY

The described techniques relate to improved methods, systems, devices, and apparatuses that support pre-indication for high mobility systems. For example, the described techniques provide for a network entity to indicate a set of communication parameters for a user equipment (UE) to use for communications when the UE subsequently wakes up after operating in an inactive state for a time period. The network entity may transmit a control signal to the UE while the UE operates in an active state. The active state may be associated with the UE monitoring for a physical downlink control channel (PDCCH). The control signal may indicate the set of communication parameters and may include a request for the UE to transition to an inactive state. For example, the control signal may be a downlink control information (DCI) message including a PDCCH skipping indicator, or a medium access control-control element (MAC-CE).

The UE may transition from the active state to the inactive state based on or in response to the control signal including the request for the UE to transition to the inactive state. The inactive state may be associated with the UE refraining from or skipping monitoring the PDCCH. The UE may operate in the inactive state for at least a time period, where the time period may be indicated via the control signal or based on a discontinuous reception (DRX) cycle of the UE, or both. The UE may transition back to the active state after at least the time period. The UE may operate in the active state in accordance with the set of communication parameters indicated via the control signal. The network entity may thereby utilize the control signal to request the UE to transition to the inactive state and to indicate the set of communication parameters for a subsequent active state, which may reduce overhead and resource consumption, and may improve communication reliability and throughput.

A method for wireless communication by a UE is described. The method may include receiving, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel, transitioning from the active state to the inactive state for at least the time period based on the control signal, and operating in the active state after at least the time period in accordance with the set of one or more communication parameters indicated via the control signal.

An apparatus for wireless communication at a UE is described. The apparatus may include at least one processor and at least one memory coupled with the at least one processor. The instructions may be executable by the at least one processor, individually or in any combination, to cause the apparatus to receive, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel, transition from the active state to the inactive state for at least the time period based on the control signal, and operate in the active state after at least the time period in accordance with the set of one or more communication parameters indicated via the control signal.

Another apparatus for wireless communication at a UE is described. The apparatus may include means for receiving, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel, means for transitioning from the active state to the inactive state for at least the time period based on the control signal, and means for operating in the active state after at least the time period in accordance with the set of one or more communication parameters indicated via the control signal.

A non-transitory computer-readable medium storing code for wireless communication at a UE is described. The code may include instructions executable by a processor to receive, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel, transition from the active state to the inactive state for at least the time period based on the control signal, and operate in the active state after at least the time period in accordance with the set of one or more communication parameters indicated via the control signal.

In some examples of the method, apparatuses, and non-transitory computer-readable medium described herein, receiving the control signal may include operations, features, means, or instructions for receiving, via a first set of one or more fields included in the control signal, the set of one or more communication parameters for the subsequent communications after operating in the inactive state for at least the time period and receiving, via a second set of one or more fields included in the control signal, a second set of one or more communication parameters associated with a transmission that may be scheduled by the control signal.

In some examples of the method, apparatuses, and non-transitory computer-readable medium described herein, receiving the control signal may include operations, features, means, or instructions for receiving, via a first field included in the control signal, one or more bits that indicate whether one or more second fields in the control signal may be associated with the set of one or more communication parameters for the subsequent communications after operating in the inactive state for at least the time period or may be associated with a second set of one or more communication parameters associated with a transmission that may be scheduled by the control signal.

In some examples of the method, apparatuses, and non-transitory computer-readable medium described herein, receiving the control signal may include operations, features, means, or instructions for receiving, via one or more first fields included in the control signal, a second set of one or more communication parameters associated with a transmission scheduled by the control signal and receiving, via at least one second field included in the control signal, an indication that indicates a difference between the second set of one or more communication parameters and the set of one or more communication parameters for the subsequent communications after operating in the inactive state for at least the time period.

In some examples of the method, apparatuses, and non-transitory computer-readable medium described herein, receiving the control signal may include operations, features, means, or instructions for receiving, via one or more fields included in the control signal, a time offset, a frequency offset, a control resource set (CORESET), or any combination thereof for the subsequent communications, where the set of one or more communication parameters includes the time offset, the frequency offset, the CORESET, or any combination thereof.

In some examples of the method, apparatuses, and non-transitory computer-readable medium described herein, receiving the control signal may include operations, features, means, or instructions for receiving the control signal including one or more fields that may be repurposed to indicate the set of one or more communication parameters for the subsequent communications.

In some examples of the method, apparatuses, and non-transitory computer-readable medium described herein, operating in the active state may include operations, features, means, or instructions for operating in the active state in accordance with the set of one or more communication parameters indicated via the control signal based on the control signal including a downlink control channel skipping indication.

In some examples of the method, apparatuses, and non-transitory computer-readable medium described herein, receiving the control signal may include operations, features, means, or instructions for receiving DCI including a downlink control channel skipping indication and the set of one or more communication parameters, where the downlink control channel skipping indication indicates the request for the UE to transition to the inactive state for at least the time period.

Some examples of the method, apparatuses, and non-transitory computer-readable medium described herein may further include operations, features, means, or instructions for transitioning, based on the control signal indicating the time period, from the inactive state to the active state after the time period expires.

In some examples of the method, apparatuses, and non-transitory computer-readable medium described herein, receiving the control signal may include operations, features, means, or instructions for receiving, during an active duration of a DRX cycle of the UE, a MAC-CE that includes the request for the UE to transition to the inactive state associated with an inactive duration of the DRX cycle and that includes the set of one or more communication parameters, where the UE transitions from the inactive state back to the active state after at least the time period in accordance with the DRX cycle.

Some examples of the method, apparatuses, and non-transitory computer-readable medium described herein may further include operations, features, means, or instructions for transitioning from the inactive state to the active state after at least the time period in accordance with a DRX cycle of the UE, where the control signal may be received during an active duration of the DRX cycle of the UE, and where transitioning to the active state occurs after an inactive duration of the DRX cycle of the UE expires.

In some examples of the method, apparatuses, and non-transitory computer-readable medium described herein, the set of one or more communication parameters includes a timing offset, a frequency offset, a beam, a bandwidth part, a CORESET, or any combination thereof for the subsequent communications.

A method for wireless communication by a network entity is described. The method may include transmitting, to a UE that is operating in an active state, a control signal including a request for the UE to transition to an inactive state for at least a time period, the control signal including a set of one or more communication parameters for subsequent communications in the active state after the UE operates in the inactive state for at least the time period and transmitting, after at least the time period, a downlink communication in accordance with the set of one or more communication parameters indicated via the control signal.

An apparatus for wireless communication at a network entity is described. The network entity may include at least one processor and at least one memory coupled with the at least one processor, with instructions stored in the at least one memory. The instructions may be executable by the at least one processor, individually or in any combination, to cause the apparatus to transmit, to a UE that is operating in an active state, a control signal including a request for the UE to transition to an inactive state for at least a time period, the control signal including a set of one or more communication parameters for subsequent communications in the active state after the UE operates in the inactive state for at least the time period and transmit, after at least the time period, a downlink communication in accordance with the set of one or more communication parameters indicated via the control signal.

Another apparatus for wireless communication at a network entity is described. The network entity may include means for transmitting, to a UE that is operating in an active state, a control signal including a request for the UE to transition to an inactive state for at least a time period, the control signal including a set of one or more communication parameters for subsequent communications in the active state after the UE operates in the inactive state for at least the time period and means for transmitting, after at least the time period, a downlink communication in accordance with the set of one or more communication parameters indicated via the control signal.

A non-transitory computer-readable medium storing code for wireless communication at a network entity is described. The code may include instructions executable by a processor to transmit, to a UE that is operating in an active state, a control signal including a request for the UE to transition to an inactive state for at least a time period, the control signal including a set of one or more communication parameters for subsequent communications in the active state after the UE operates in the inactive state for at least the time period and transmit, after at least the time period, a downlink communication in accordance with the set of one or more communication parameters indicated via the control signal.

In some examples of the method, apparatuses, and non-transitory computer-readable medium described herein, transmitting the control signal may include operations, features, means, or instructions for transmitting, via a first set of one or more fields included in the control signal, the set of one or more communication parameters for the subsequent communications in the active state after at least the time period and transmitting, via a second set of one or more fields included in the control signal, a second set of one or more communication parameters associated with a transmission that may be scheduled by the control signal.

In some examples of the method, apparatuses, and non-transitory computer-readable medium described herein, transmitting the control signal may include operations, features, means, or instructions for transmitting, via a first field included in the control signal, one or more bits that indicate whether one or more second fields in the control signal may be associated with the set of one or more communication parameters for the subsequent communications in the active state after at least the time period or may be associated with a second set of one or more communication parameters associated with a transmission that may be scheduled by the control signal.

In some examples of the method, apparatuses, and non-transitory computer-readable medium described herein, transmitting the control signal may include operations, features, means, or instructions for transmitting, via one or more first fields included in the control signal, a second set of one or more communication parameters associated with a transmission scheduled by the control signal and transmitting, via at least one second field included in the control signal, an indication that indicates a difference between the second set of one or more communication parameters and the set of one or more communication parameters for the subsequent communications in the active state after at least the time period.

In some examples of the method, apparatuses, and non-transitory computer-readable medium described herein, transmitting the control signal may include operations, features, means, or instructions for transmitting, via one or more fields included in the control signal, a time offset, a frequency offset, a CORESET, or any combination thereof for the subsequent communications, where the set of one or more communication parameters includes the time offset, the frequency offset, the CORESET, or any combination thereof.

In some examples of the method, apparatuses, and non-transitory computer-readable medium described herein, transmitting the control signal may include operations, features, means, or instructions for transmitting the control signal including one or more fields that may be repurposed to indicate the set of one or more communication parameters for the subsequent communications in the active state after at least the time period.

In some examples of the method, apparatuses, and non-transitory computer-readable medium described herein, transmitting the control signal may include operations, features, means, or instructions for transmitting DCI including a downlink control channel skipping indication and the set of one or more communication parameters, where the downlink control channel skipping indication indicates the request for the UE to transition to the inactive state for at least the time period.

In some examples of the method, apparatuses, and non-transitory computer-readable medium described herein, transmitting the control signal may include operations, features, means, or instructions for transmitting, during an active duration of a DRX cycle of the UE, a MAC-CE that includes the request for the UE to transition to the inactive state associated with an inactive duration of the DRX cycle and that includes the set of one or more communication parameters.

In some examples of the method, apparatuses, and non-transitory computer-readable medium described herein, transmitting the control signal may include operations, features, means, or instructions for transmitting the control signal during an active duration of a DRX cycle of the UE.

In some examples of the method, apparatuses, and non-transitory computer-readable medium described herein, the set of one or more communication parameters includes a timing offset, a frequency offset, a beam, a bandwidth part, a CORESET, or any combination thereof for the subsequent communications.

### BRIEF DESCRIPTION OF THE DRAWINGS

FIG. 1 shows an example of a wireless communications system that supports pre-indication for high mobility systems in accordance with one or more aspects of the present disclosure.

FIG. 2 shows an example of a wireless communications system that supports pre-indication for high mobility systems in accordance with one or more aspects of the present disclosure.

FIG. 3 shows an example of discontinuous reception (DRX) scheme that supports pre-indication for high mobility systems in accordance with one or more aspects of the present disclosure.

FIGS. 4A-4C show examples of control signal configurations that support pre-indication for high mobility systems in accordance with one or more aspects of the present disclosure.

FIG. 5 shows an example of a process flow that supports pre-indication for high mobility systems in accordance with one or more aspects of the present disclosure.

FIGS. 6 and 7 show block diagrams of devices that support pre-indication for high mobility systems in accordance with one or more aspects of the present disclosure.

FIG. 8 shows a block diagram of a communications manager that supports pre-indication for high mobility systems in accordance with one or more aspects of the present disclosure.

FIG. 9 shows a diagram of a system including a device that supports pre-indication for high mobility systems in accordance with one or more aspects of the present disclosure.

FIGS. 10 and 11 show block diagrams of devices that support pre-indication for high mobility systems in accordance with one or more aspects of the present disclosure.

FIG. 12 shows a block diagram of a communications manager that supports pre-indication for high mobility systems in accordance with one or more aspects of the present disclosure.

FIG. 13 shows a diagram of a system including a device that supports pre-indication for high mobility systems in accordance with one or more aspects of the present disclosure.

FIGS. 14 through 18 show flowcharts illustrating methods that support pre-indication for high mobility systems in accordance with one or more aspects of the present disclosure.

### DETAILED DESCRIPTION

In some wireless communications systems, a user equipment (UE) may perform discontinuous reception (DRX) to reduce power consumption. In a DRX mode, the UE may transition between an active state and an inactive state in accordance with a DRX periodicity. The active state may be associated with monitoring, by the UE, for a physical downlink control channel (PDCCH). During the inactive state, the UE may refrain from monitoring the PDCCH to reduce power consumption. In some examples, the active state and the inactive state may be referred to as high and low power modes, on and off durations, or wake and sleep modes, respectively. A network entity may transmit a control signal (e.g., a PDCCH skipping indication or a medium access control-control element (MAC-CE)) that requests the UE to skip monitoring PDCCH for a time period (e.g., that requests the UE to enter the inactive state). The control signal may be transmitted while the UE operates in the active state (e.g., during a DRX active duration), and the UE may transition to the inactive state based on (in response to, after) the signal. If the UE does not operate according to a DRX cycle, the control signal may trigger the UE to pause PDCCH monitoring for a time period. If the network changes communication parameters (e.g., beams, bandwidth, frequency, resource sets, or the like) while the UE is operating in an inactive mode, the UE may perform blind decoding or a random access procedure upon wake-up to determine parameters to use to monitor for PDCCH in the active state, which may increase processing and latency.

Techniques, systems, and devices described herein provide for the network entity to indicate, to the UE via the control signaling that requests the UE to transition to the inactive state, communication parameters for the UE to use to monitor PDCCH when the UE transitions back to the active state after operating in the inactive state. The communication parameters may be, for example, a bandwidth part (BWP), a beam, a time offset, a frequency offset, a resource set (e.g., a control resource set (CORESET)), or the like. The network entity may estimate, calculate, or predict the set of communication parameters that may be applicable at a subsequent time when the UE wakes up based on one or more metrics (e.g., a relative speed or velocity of the UE and the network entity, past communications, a machine learning model, other metrics, or any combination thereof). The control signaling may include one or more fields to indicate the communication parameters for the subsequent active state. If the control signaling schedules a transmission by the UE or the network entity, the control signaling may indicate communication parameters for the scheduled transmission, communication parameters for the subsequent active state, or both. If the control signaling does not schedule a transmission, the fields in the control signaling may be repurposed to indicate the parameters for the subsequent active state.

The control signaling may be a MAC-CE or a DCI message including a PDCCH switching indicator that requests the UE to enter a DRX inactive duration early or before the UE would enter the inactive duration based on the DRX cycle. If the UE does not operate according to a DRX cycle, the control signaling may be DCI including a PDCCH switching indicator that requests the UE to pause PDCCH monitoring for a time period (e.g., enter an inactive state). A UE may thereby receive control signaling, transition to an inactive state for a duration, transition back to an active state, and perform communications in the active state using the parameters indicated via the control signaling without performing a random access procedure, which may improve reliability and communication throughput, and may reduce processing and latency.

Aspects of the disclosure are initially described in the context of wireless communications systems. Additional aspects of the disclosure are described herein with reference to a DRX scheme, control signaling configurations, and a process flow. Aspects of the disclosure are further illustrated by and described herein with reference to apparatus diagrams, system diagrams, and flowcharts that relate to pre-indication for high mobility systems.

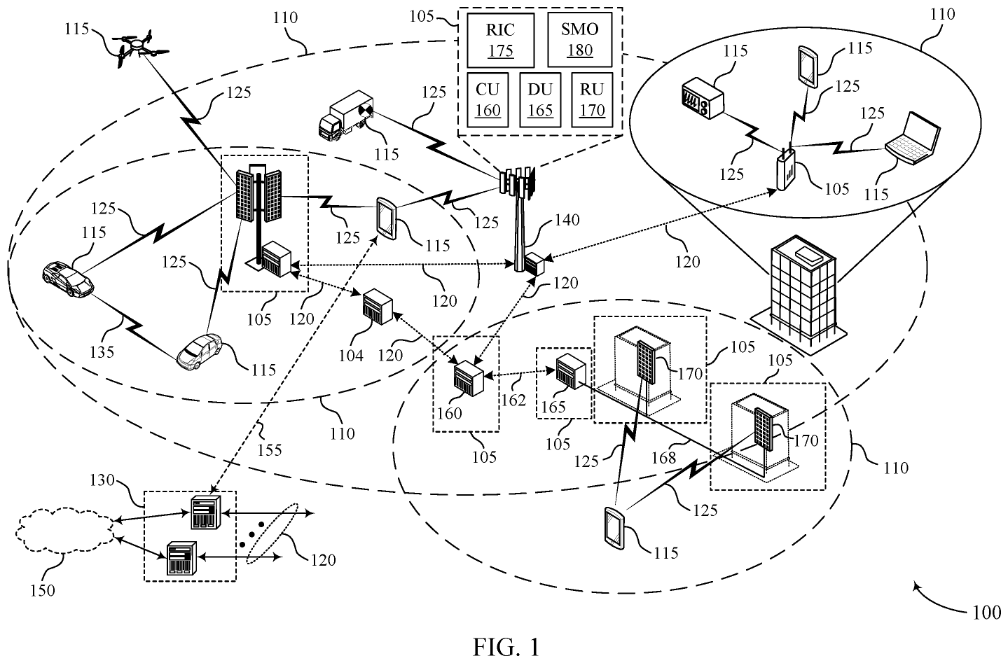

FIG. 1 shows an example of a wireless communications system 100 that supports pre-indication for high mobility systems in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support pre-indication for high mobility systems as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a network entity 105 in the wireless communications system 100 may indicate, to a UE 115, a set of communication parameters for the UE 115 to use for communications when the UE 115 subsequently wakes up after operating in an inactive state for a time period. The network entity 105 may transmit a control signal to the UE 115 while the UE 115 operates in an active state. The active state may be associated with the UE 115 monitoring for a PDCCH. The control signal may indicate the set of communication parameters and may include a request for the UE 115 to transition to an inactive state. For example, the control signal may be a DCI message including a PDCCH skipping indicator, or a MAC-CE.

The UE 115 may transition from the active state to the inactive state based on or in response to the control signal including the request for the UE 115 to transition to the inactive state. The inactive state may be associated with the UE 115 refraining from or skipping monitoring the PDCCH. The UE 115 may operate in the inactive state for at least a time period, where the time period may be indicated via the control signal or based on a DRX cycle of the UE 115, or both. The UE 115 may transition back to the active state after at least the time period. The UE 115 may operate in the active state in accordance with the set of communication parameters indicated via the control signal. The network entity 105 may thereby utilize the control signal to request the UE 115 to transition to the inactive state and to indicate the set of communication parameters for a subsequent active state, which may reduce overhead and resource consumption, and may improve communication reliability and throughput.

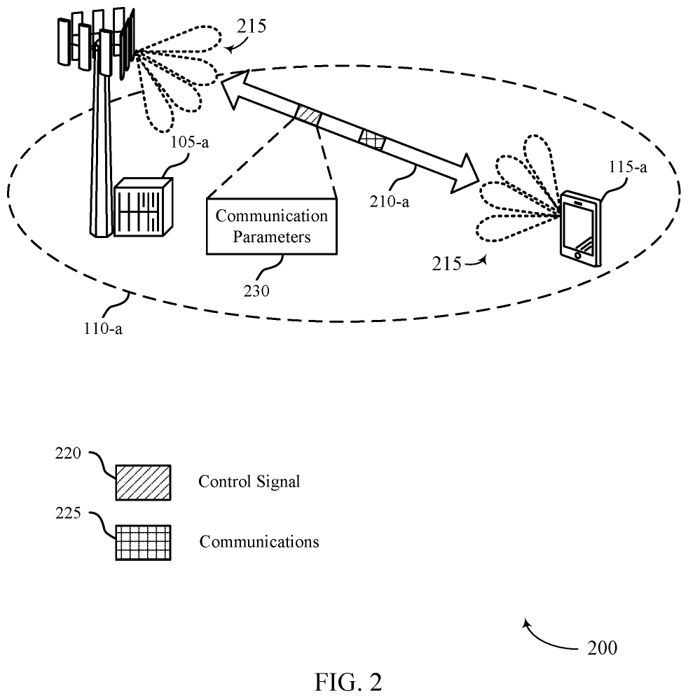

FIG. 2 shows an example of a wireless communications system 200 that supports pre-indication for high mobility systems in accordance with one or more aspects of the present disclosure. The wireless communications system 200 may implement or be implemented by aspects of the wireless communications system 100. For example, the wireless communications system 200 may include a UE 115-a and a network entity 105-a, which may represent examples of a UE 115 and a network entity 105 as described herein with reference to FIG. 1. The UE 115-a may communicate with the network entity 105-a within the geographic coverage area 110-a and via a communication link 210-a. The UE 115-a may, in some examples, communicate with (e.g., switch to communicating with) the network entity 105-a via one or more nodes, such as transmission/reception points (TRPs) or remote radio heads (RRHs) (not pictured). In this example, the network entity 105-a may transmit a control signal 220 to the UE 115-a to indicate communication parameters 230 for the UE 115-a to use for subsequent communications 225.

The UE 115-a and the network entity 105-a may communicate using one or more beams 215. In some examples, the UE 115-a, the network entity 105-a, or both may switch beams 215 used for communications based on a change of position of the device, based on channel measurements, based on feedback, or any combination thereof.

In the example of the wireless communications system 200, the UE 115-a and/or the network entity 105-a may be relatively mobile (e.g., may change position over time). In some examples, the network entity 105-a may be a satellite or other mobile network node. For example, the network entity 105-a may be in orbit. In some examples, such as low Earth orbit (LEO) non-terrestrial networks (NTN), a satellite (e.g., the network entity 105-a) may support a relatively large quantity of beams 215 (e.g., tens to hundreds of beams 215) for relatively wide coverage area for the UE 115-a (e.g., a cell phone or other device) to access the network. The UE 115-a may have a relatively short dwelling time within each beam 215, such that the UE 115-a may be continuously or near-continuously covered by a respective beam 215 for a time period (e.g., a few seconds, or some other time period).

In some other examples, the UE 115-a may be moving relatively quickly. For example, the UE 115-a may be on a high speed train or some other vehicle. The UE 115-a may exit a coverage area of a first node of the network entity 105-a and may enter a coverage area of a second node of the network entity 105-a (not shown). In this example, the UE 115-a may switch to communicating with the second network node of the network entity 105-a, such as a TRP, an RRH, some other type of network node, or any combination thereof.

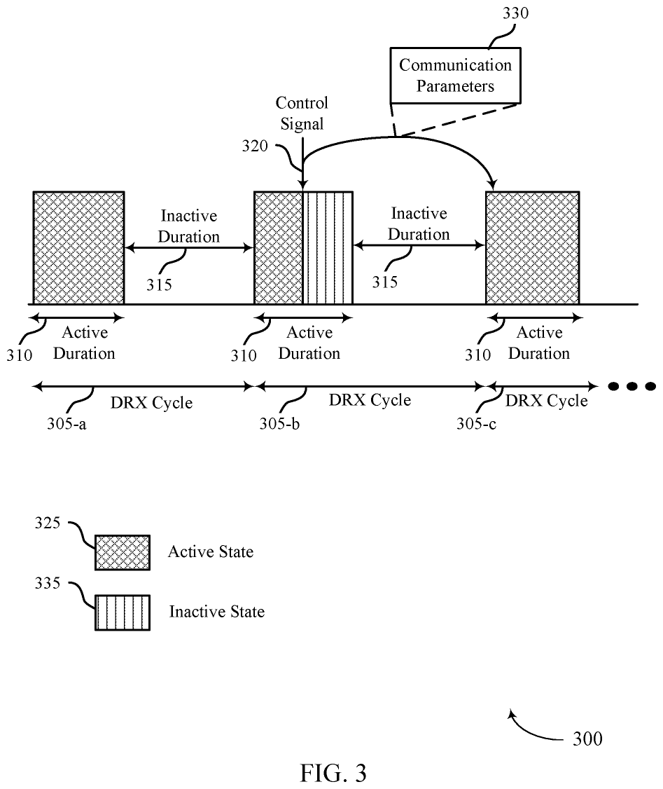

In some examples described herein, the UE 115-a may operate in a DRX mode. For example, the network may configure connected mode DRX (CDRX) for the UE 115-a in a radio resource control (RRC) connected mode for power savings. While operating in the CDRX mode, the UE 115-a may operate in an active state (e.g., a high power state) for a duration and may switch to an inactive state (e.g., a low power state) after the UE 115-a finishes a data exchange (e.g., in bursts or continuous data) with the network entity 105-a. The UE 115-a may remain in the inactive state for a remainder of a CDRX cycle. The UE 115-a may transition back to the active state after the CDRX cycle, where a CDRX cycle may be some time period (e.g., 10 milliseconds, several seconds, or some other time period) based on a traffic pattern. DRX cycle configurations are described in further detail elsewhere herein, including with reference to FIG. 3.

If the UE 115-a operates in the CDRX mode and the UE 115-a or the network entity 105-a are relatively mobile, such as in NTN systems or HST scenarios, one or more communication parameters 230 may change during the time period in which the UE 115-a operates in an inactive state between two active states. For example, downlink timing and frequency offsets configured for a first active state of the UE 115-a may have change slightly or relatively significantly (e.g., due to mobility or beam changes) by the time the UE 115-a returns to the active state. In some examples, the UE 115-a may have entered a different satellite beam 215 or a different geographic coverage area 110 after the UE 115-a returns to the active state, and an active BWP or CORESET may be different (e.g., if the BWP or CORESET is associated with a beam 215).

Techniques, systems, and devices described herein provide for the network entity 105-a to indicate communication parameters 230 for the UE 115-a to use in a subsequent active state. For example, the network entity 105-a may estimate (e.g., predict, calculate, or determine) the communication parameters 230 that may be applicable to the UE 115-a in a subsequent DRX cycle or at a later time. The network entity 105-a may estimate the communication parameters 230 based on a machine learning model, one or more measurements or calculations, previous communications, some other technique, or any combination thereof. In some examples, the network entity 105-a may measure a velocity and/or acceleration of the network entity 105-a, the UE 115-b, or both (e.g., a relative speed), and may calculate the communication parameters 230 based on the measured speeds.

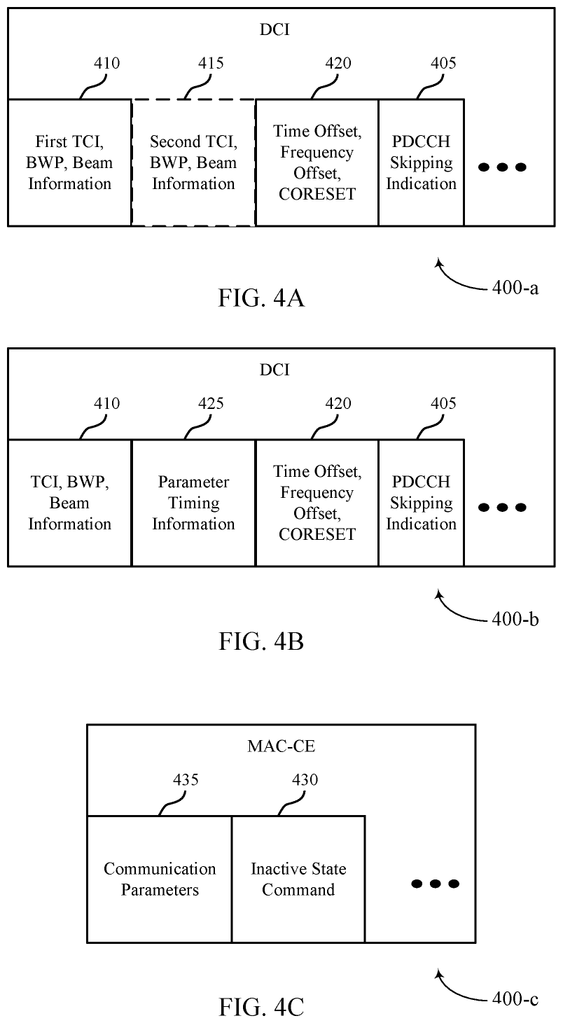

The network entity 105-a may indicate the communication parameters 230 to the UE 115-a via a control signal 220. The control signal 220 may additionally include a request for the UE 115-a to transition to an inactive state. By indicating the communication parameters 230 in the control signal 220, the network entity 105-a may reduce overhead and processing. The control signal 220 may be a DCI message, a MAC-CE, or some other type of control signal that includes one or more fields or bits configured to indicate the communication parameters 230, as described in further detail elsewhere herein, including with reference to FIGS. 4A-4C.

The UE 115-a may transition to the inactive state based on (e.g., after or in response to) the control signal 220. The UE 115-a may operate in the inactive state for at least a time period, where the control signal 220 may indicate the time period. In some examples, the UE 115-a may operate in the inactive state for the time period and may transition back to the active state when the time period expires. Additionally, or alternatively, the UE 115-a may operate in the inactive state for the time period and any additional duration of time associated with a DRX inactive duration, and the UE 115-a may transition back to the active state at the start of a next DRX cycle. In some other examples, the time period may expire while the UE 115-a is still in an active duration of the DRX cycle, and the UE 115-a may transition back to the active state for a remainder of the active duration.

Once the UE 115-a transitions back to the active state after operating in the inactive state for at least the time period, the UE 115-a may operate in the active state in accordance with the one or more communication parameters 230 indicated via the control signal 220. In some examples, the UE 115-a may utilize the one or more communication parameters immediately when the UE 115-a wakes up (e.g., if the UE 115-a is inactive until a next DRX cycle). Additionally, or alternatively, the UE 115-a may perform one or more other communications before utilizing the one or more communication parameters 230. For example, if the UE 115-a transitions back to the active state within a same active duration of a same DRX cycle, the UE 115-a may continue to use previous parameters for communications until a next DRX cycle.

Operating in the active state according to the one or more communication parameters 230 may include the UE 115-a communicating with the network entity 105-a (e.g., or a TRP associated with the network entity 105-a or some other network entity 105) according to the time offset, the frequency offset, the beam 215, the BWP, the CORESET, or any combination thereof indicated via the control signal 220. The UE 115-a may thereby know which communication parameters 230 to use for subsequent uplink and/or downlink communications based on the control signal, which may reduce processing at the UE 115-a and improve communication reliability.

The network entity 105-a may thereby proactively predict and indicate communication parameters 230 for the UE 115-a to use later when the UE 115-a operates in an inactive state and does not monitor for a downlink control channel for at least a time period to improve communication reliability and throughput.

FIG. 3 shows an example of a DRX scheme 300 that supports pre-indication for high mobility systems in accordance with one or more aspects of the present disclosure. The DRX scheme 300 may implement or be implemented by aspects of the wireless communications systems 100 and 200. For example, the DRX scheme 300 illustrates a timeline for a UE 115 to transition between an active state 325 and an inactive state 335 of a DRX mode while communicating with a network entity 105. The UE 115 and the network entity 105 may represent examples of corresponding devices as described herein with reference to FIGS. 1 and 2. In this example, the network entity 105 may transmit a control signal 320 to the UE 115 to request the UE 115 to transition to the inactive state 335 and to indicate a set of communication parameters 330 for subsequent communications by the UE 115.

The UE 115 may be configured to operate in a DRX mode via RRC signaling or some other type of signaling. For example, the network entity 105 may configure the UE 115 with a DRX cycle periodicity for one or more DRX cycles 305 (e.g., a cycle duration or periodicity for the DRX cycles 305-a, 305-b, and 305-c) and one or more other DRX parameters. The UE 115 may transition between DRX cycles 305 according to the configuration. In each DRX cycle 305, the UE 115 may operate in the active state 325 for an active duration 310 and then transition to the inactive state 335 for an inactive duration 315. The active duration 310 may be the same or different in each DRX cycle 305 and the inactive duration 315 may be the same or different in each DRX cycle 305. In some examples, the active duration 310 may be associated with some portion or percentage of the DRX cycle 305 (e.g., a duty cycle).

The UE 115 may monitor for a PDCCH while operating in the active state 325 and may refrain from monitoring for the PDCCH while operating in the inactive state 335 to reduce power consumption. In some examples, the UE 115 may start or reset a DRX inactivity timer after the UE 115 receives a PDCCH in the active state 325. The UE 115 may run the inactivity timer until the timer expires or until the UE 115 receives a PDCCH. If the inactivity timer expires before the UE 115 receives a PDCCH, the UE 115 may transition to the inactive state 335 early (e.g., even if the active duration 310 is not over) to reduce power consumption. In some examples, the PDCCH schedules a new transmission for a downlink or uplink data.

In some examples described herein, the network entity 105 may request the UE 115 to transition to the inactive state 335 before the end of the active duration 310 of a DRX cycle 305. The network entity 105 may transmit a control signal 320 that includes the request for the UE 115 to transition to the inactive state. The control signal 320 may be a DCI including a PDCCH skipping indication or a MAC-CE. In some examples, the control signal 320 may indicate a time period for which the UE 115 is to transition to the inactive state. The UE 115 may transition to the inactive state 335 for at least the time period. If the time period expires before an end of the active duration 310 during which the control signal 320 was received (not pictured in FIG. 3), the UE 115 may transition back to the active state 325 for a remainder of the active duration 310 and then may transition to the inactive state 335 for the inactive duration 315 of the DRX cycle 305. If the time period expires at the same time as or after the active duration 310 ends, the UE 115 may remain in the inactive state for a remainder of the DRX cycle 305. The UE 115 may transition to the active state 325 at the start of the active duration 310 of the next DRX cycle 305.

In the example illustrated in FIG. 3, the control signal 320 may be a DCI message or a MAC-CE that is transmitted to the UE 115 while the UE 115 operates in the active state 325 of a DRX cycle 305. Although not illustrated in FIG. 3, it is to be understood that, in some examples, the UE 115 may receive a control signal 320 when the UE 115 does not operate in a DRX mode. For example, the UE 115 may continuously operate in the active state 325 until the UE 115 receives the control signal 320, at which point the UE 115 may transition to an inactive state 335 for a time period indicated via the control signal 320. In such cases, the control signal 320 may be a DCI message including a PDCCH skipping indication.

If the UE 115 operates in a relatively mobile system, such as an NTN or HST scenario, among other examples, communication parameters 330 that the UE 115 uses during a first active duration 310 (e.g., the active duration 310 of the DRX cycle 305-b) may change before a next active duration 310, such as the active duration 310 of the DRX cycle 305-c). For example, the UE 115 may change geographic coverage areas, beams, or some other parameters associated with the connection between the UE 115 and the network may change. If the UE 115 performs blind decoding or a random access procedure at the start of each active duration 310, the UE 115 may consume a relatively large amount of power and processing resources.

Techniques, systems, and devices described herein provide for the network entity 105 to indicate communication parameters 330 for the UE 115 to use in a subsequent active duration, such that the UE 115 may refrain from performing a random access procedure or other procedure to determine parameters each time the UE 115 wakes up. The network entity 105 may transmit the indication of the communication parameters 330 via the control signal 320 that requests the UE 115 to transition to the inactive state. By indicating the communication parameters 330 via the control signal 320, the network entity 105 may refrain from transmitting multiple signals to the UE 115, which may reduce overhead and latency.

The UE 115 may receive the control signal 320 and transition to the inactive state 335 based on the control signal 320. When the UE 115 subsequently transitions to the active state 325 in the next DRX cycle 305-c, the UE 115 may know to apply the set of communication parameters 330 indicated via the control signal 320 to communications in the active state 325. The communication parameters 330 may include, for example, a time offset, a frequency offset, a beam, a BWP, a CORESET, one or more other parameters, or any combination thereof. The UE 115 may thereby refrain from blind decoding or performing random access at the next active duration 310 because the UE 115 may utilize the communication parameters 330 previously indicated.

The control signal 320 may include one or more fields configured to indicate the communication parameters 330, as described in further detail elsewhere herein, including with reference to FIGS. 4A-4C.

FIGS. 4A-4C show examples of control signal configurations 400 that support pre-indication for high mobility systems in accordance with one or more aspects of the present disclosure. The control signal configurations 400-a, 400-b, and 400-c may implement or be implemented by aspects of the wireless communications systems 100 and 200 and the DRX scheme 300 described herein with reference to FIGS. 1-3. For example, the control signal configurations 400-a, 400-b, and 400-c illustrate example configurations of control signals that are transmitted by a network entity 105 to a UE 115. The network entity 105 and the UE 115 may represent examples of corresponding devices as described herein with reference to FIGS. 1-3. In this example, the control signal may include one or more fields to indicate communication parameters for the UE 115 to apply during a subsequent active duration.

FIG. 4A illustrates a first example control signal configuration 400-a. The control signal configuration 400-a illustrates a configuration of a DCI message including a PDCCH skipping indication 405, which may be a field or bit in the DCI message that requests to the UE 115 to pause monitoring for a PDCCH for at least a time period. In this example, the DCI message may include one or more first fields 410 that indicate a first set of communication parameters for a transmission scheduled by the DCI message and a second set of one or more fields 415 and/or a third set of one or more fields 420 that indicate a second set of communication parameters for subsequent communications by the UE 115 during a next active duration.

The DCI message may be transmitted by a network entity 105 to the UE 115 while the UE 115 operates in an active state (e.g., while the UE 115 monitors for PDCCH). In some examples, the DCI message may be transmitted during an active duration of a DRX cycle of the UE 115, and the PDCCH skipping indication 405 may terminate the DRX active duration before an end of the active duration or before a DRX inactivity timer expires for the UE 115 to transition into a DRX inactive state.

In some other examples, the DCI message may be transmitted to a UE 115 that does not operate in a DRX mode. That is, the DCI message carrying the PDCCH skipping indication 405 may be transmitted even when DRX is not configured. In such cases, the PDCCH skipping indication 405 may request the UE 115 to pause monitoring for PDCCH for at least a time period to reduce power consumption. The PDCCH skipping indication 405 may be selected from a set of candidate PDCCH skipping duration values (e.g., up to three candidate durations, or some other quantity). For example, the network entity 105 may configure a set of candidate PDCCH skipping durations (e.g., time periods for pausing PDCCH monitoring) and the PDCCH skipping indication 405 in the DCI may indicate an index or pointer to one of the candidate PDCCH skipping values. That is, the time period for which the UE 115 may enter the inactive state and skip monitoring PDCCH may be indicated via the PDCCH skipping indication 405.

As described herein, the network entity 105 may include, in the DCI message, information for the UE 115 to use when the UE 115 resumes monitoring PDCCH again after a PDCCH skipping duration. In the example of FIG. 4A, the DCI message may include a first set of information associated with a transmission scheduled by the DCI message and a second set of information including the communication parameters for the UE 115 to use when the UE 115 resumes monitoring PDCCH again.

For example, the first set of one or more fields 410 in the DCI message may include a first TCI field for indicating a first TCI state for the UE 115 to use to receive or transmit a message that is scheduled by the DCI. The first set of one or more fields 410 may additionally, or alternatively, include a first BWP indicator field that indicates a BWP for the UE 115 to use to receive or transmit the scheduled message, or one or more other fields or bits including other parameters associated with the transmission scheduled by the DCI, such as beam information for the transmission. The UE 115 may receive or transmit the scheduled message in accordance with the information conveyed via the first set of one or more fields 410.

The DCI message may additionally include a second set of one or more fields 415 that may include second information for the UE 115 to use when the UE 115 resumes PDCCH monitoring. For example, the second set of one or more fields 415 may include a second TCI field for a second TCI state that the UE 115 may assume after the UE 115 resumes PDCCH monitoring, or a second BWP indicator field that indicates a BWP for the UE 115 to assume after the UE 115 resumes PDCCH monitoring, or both. In some examples, the second set of one or more fields 415 may include a field or bit that indicates beam information for the UE 115 to assume after the UE 115 resumes PDCCH monitoring, such as a transmit beam, a receive beam, or both.

In some examples, the UE 115 may be configured to assume that the one or more first fields 410 indicate information for the UE 115 to use immediately or for a transmission scheduled by the DCI. In such cases, the second set of one or more fields 415 (e.g., a single field or bit) may indicate a change in the communication parameters indicated via the one or more first fields 410. That is, the second set of one or more fields 415 may indicate an offset between one or more of the first communication parameters indicated via the first fields 410 and second communication parameters for the UE 115 to use when the UE 115 resumes PDCCH monitoring. In some examples, the second set of one or more fields 415 may indicate an offset between a beam, a BWP, a CORESET and a second beam, a second BWP, and a second CORESET, or any combination thereof. The UE 115 may apply the change to the first set of communication parameters indicated via the one or more first fields 410 and may use the changed parameters during subsequent communications when the UE 115 resumes PDCCH monitoring.

In some examples, the one or more second fields 415 may include a single bit that indicate a neighboring beam, BWP, and/or CORESET, or the one or more second fields 415 may include multiple bits that indicate a certain neighboring beam, BWP, and/or CORESET. For example, the one or more second fields 415 may include a bit map or some other mapping information that indicates the offset between parameters.

The DCI message described herein may further include a third set of one or more fields 420 that indicate a time offset, a frequency offset, a CORESET, one or more other communication parameters, or any combination thereof for the UE 115 to use when the UE 115 resumes PDCCH monitoring. Such communication parameters may or may not be indicated for the transmission scheduled by the DCI message. Although illustrated as separate fields in FIG. 4A, it is to be understood that the second set of one or more fields 415 and the third set of one or more fields 420 may be combined or transmitted in any order within the DCI message to indicate communication parameters for the UE 115 to use when the UE 115 resumes PDCCH monitoring.

In this example, the UE 115 may receive the DCI message including the PDCCH skipping indication 405, a first set of information for the UE 115 to use for a transmission scheduled by the DCI message, and a second set of information including communication parameters for the UE 115 to use when the UE 115 resumes PDCCH monitoring after an inactive duration.

In some other examples, the DCI message may not include the second set of one or more fields 415. In such cases, the UE 115 may be configured (e.g., pre-configured or configured via control signaling) to assume the communication parameters indicated via the first set of one or more fields 410 are to be applied after the UE 115 wakes up if the DCI indicates PDCCH skipping. That is, if the DCI message includes the PDCCH skipping indication 405, the UE 115 may apply the parameters indicated via the DCI to subsequent communications after the UE 115 operates in an inactive state and transitions back to the active state.

In some examples, the DCI message may not include the second set of one or more fields 415 if the DCI message is a non-scheduling DCI (e.g., based on a DCI format for data scheduling but containing invalid scheduling information in a frequency domain resource allocation (FDRA) field of the DCI). In such cases, more bits in the DCI message may be used to indicate more candidate PDCCH skipping values than if the DCI message schedules a transmission. As described herein, if the DCI message does not schedule a transmission, one or more of the first fields 410 in the DCI message or other fields (e.g., time domain resource allocation (TDRA) field, FDRA field, or other fields configured to convey scheduling information) may be repurposed to indicate communication parameters for the UE 115 to apply when the UE 115 resumes PDCCH monitoring (e.g., instead of indicating current parameters).

FIG. 4B illustrates a second example control signal configuration 400-b. The control signal configuration 400-b illustrates a configuration of a DCI message including a PDCCH skipping indication 405, which may be a field or bit in the DCI message that requests to the UE 115 to pause monitoring for a PDCCH for at least a time period. The DCI message may be transmitted by a network entity 105 to the UE 115 while the UE 115 operates in an active state (e.g., while the UE 115 monitors for PDCCH).

In some examples, the DCI message may be transmitted during an active duration of a DRX cycle of the UE 115, and the PDCCH skipping indication 405 may terminate the DRX active duration before an end of the active duration or before a DRX inactivity timer expires for the UE 115 to transition into a DRX inactive state.

In some other examples, the DCI message may be transmitted to a UE 115 that does not operate in a DRX mode. That is, the DCI message carrying the PDCCH skipping indication 405 may be transmitted even when DRX is not configured. In such cases, the PDCCH skipping indication 405 may request the UE 115 to pause monitoring for PDCCH for at least a time period to reduce power consumption. The time period may be indicated via the PDCCH skipping indication 405 or some other bit or field in the DCI message.

In this example, the DCI message may include one or more first fields 410 that indicate a set of communication parameters and a parameter timing field 425 (e.g., a DCI field or a bit) that indicates whether the information in the one or more first fields 410 (e.g., a TCI state, BWP, beam information, or the like) is to be used by the UE 115 currently (e.g., existing behavior for a transmission scheduled by the DCI) or for subsequent communications after the UE 115 resumes PDCCH monitoring.

The DCI message described herein may further include a third set of one or more fields 420 that indicate a time offset, a frequency offset, a CORESET, one or more other communication parameters, or any combination thereof for the UE 115 to use when the UE 115 resumes PDCCH monitoring. Such communication parameters may or may not be indicated for the transmission scheduled by the DCI message. Although illustrated as separate fields in FIG. 4B, it is to be understood that the one or more first fields 410, the parameter timing field 425, and the third set of one or more fields 420 may be combined or transmitted in any order within the DCI message to indicate communication parameters for the UE 115 to use when the UE 115 resumes PDCCH monitoring.

In this example, the UE 115 may receive the DCI message including the PDCCH skipping indication 405, and a first set of information. The UE 115 may determine whether to apply the first set of information immediately or later, after the UE 115 wake up from an inactive state, based on a parameter timing field 425, based on a UE configuration and whether the DCI message includes a PDCCH skipping indication 405, or both.

FIG. 4C illustrates a third example control signal configuration 400-c. The control signal configuration 400-c illustrates a configuration of a MAC-CE command. The MAC-CE command may include (e.g., explicitly or implicitly based on a configuration of the command or an ID associated with the MAC-CE), an inactive state command 430, which may request the UE 115 to transition to an inactive state (e.g., pause monitoring PDCCH). In some examples, the MAC-CE may indicate a time period for the UE 115 to remain in the inactive state, or the MAC-CE may instruct the UE 115 to operate in the inactive state until the start of a next DRX cycle. The MAC-CE may be transmitted by a network entity 105 to the UE 115 while the UE 115 operates in a DRX active state (e.g., while the UE 115 monitors for PDCCH).

In this example, one or more fields 435 may be included in the MAC-CE to indicate future information for the UE 115. For example, the one or more fields 435 may indicate the communication parameters for the UE 115 to apply when the UE 115 resumes PDCCH monitoring or re-enters the active state. The communication parameters indicated via the MAC-CE may include a time offset, a frequency offset, a beam, a BWP, a CORESET, one or more other communication parameters, or any combination thereof.

The network entity 105 may thereby transmit a MAC-CE that requests the UE 115 to transition to an inactive state and that includes additional fields 435 to indicate communication parameters for the UE 115 to apply when the UE 115 transitions back to the active state (e.g., when the UE 115 enters the on duration of a next DRX cycle).

It is to be understood that the different control signal configurations illustrated in FIGS. 4A-4C are examples, and other configurations of fields and bits in the various control signals may be possible. For example, the various fields and bits to indicate the communication parameters may be included in the PDCCH skipping indication 405, or in some other type of control signaling, or both. Additionally, or alternatively, one or more additional fields not pictured in FIGS. 4A-4C may also be included in the control signals, or one or more fields that are pictured in FIGS. 4A-4C may be removed from the control signals, or the like.

As described herein, a network entity 105 may determine (e.g., predict, estimate, measure, or calculate) one or more communication parameters that may be applicable to communications between the network entity 105 and a UE 115 at a subsequent time when the UE 115 transitions from an inactive state back to an active state. The network entity 105 may indicate the determined communication parameters to the UE 115 via a MAC-CE or a DCI including a PDCCH skipping indication. The DCI including the PDCCH skipping indication may or may not schedule a transmission by the network entity 105 or the UE 115, and the communication parameters (e.g., time/frequency offsets, beam information, BWP, CORESET, and the like) may be indicated either via additional fields in a data scheduling DCI or via repurposed fields in a non-scheduling DCI, or some combination thereof.

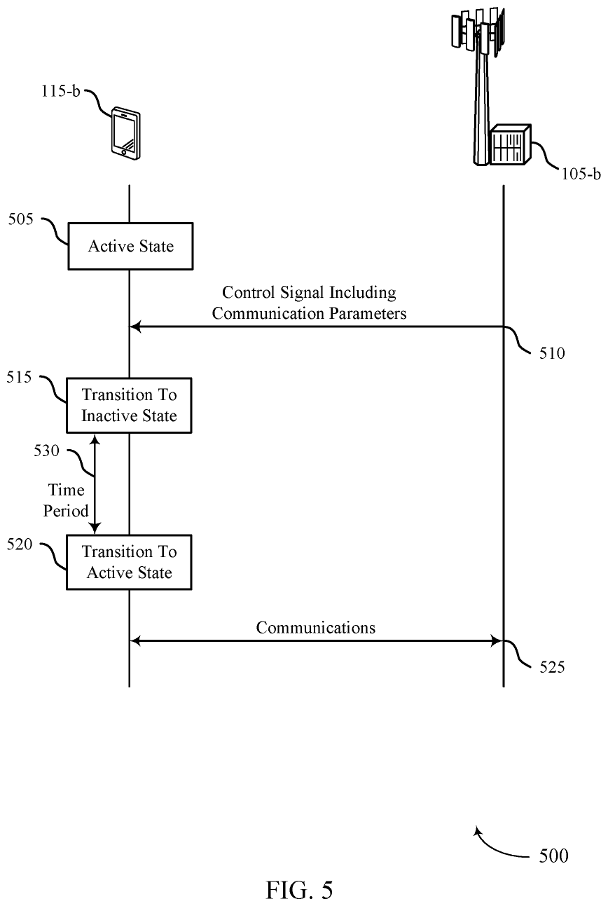

FIG. 5 shows an example of a process flow 500 that supports pre-indication for high mobility systems in accordance with one or more aspects of the present disclosure. The process flow 500 may implement or be implemented by aspects of the wireless communications systems 100 and 200, the DRX scheme 300, and the control signal configurations 400 as described herein with reference to FIGS. 1-4C. For example, the process flow 500 illustrates communications between a network entity 105-b and a UE 115-b, which may represent examples of a network entity 105 and a UE 115 as described herein with reference to FIGS. 1-4. In this example, the network entity 105-b may transmit control signaling that requests the UE 115-b to transition to an inactive state and indicates one or more communication parameters for the UE 115-b to use in a subsequent active state.

In the following description of the process flow 500, the operations between the UE 115-b and the network entity 105-b may be performed in different orders or at different times. Some operations may also be left out of the process flow 500, or other operations may be added. Although the UE 115-b and the network entity 105-b are shown performing the operations of the process flow 500, some aspects of some operations may also be performed by one or more other wireless devices.

At 505, the UE 115-b may operate in an active state. The active state may be associated with the UE 115-b monitoring for a downlink control channel (e.g., a PDCCH). The UE 115-b may additionally, or alternatively, perform one or more other types of uplink and/or downlink communications while operating in the active state. In some examples, the active state may be a baseline state for the UE 115-b, or the UE 115-b may operate in a DRX mode, and the UE 115-b may operate in the active state for at least an active duration of a DRX cycle, as described in further detail elsewhere herein, including with reference to FIG. 3.

At 510, the network entity 105-b may transmit, to the UE 115-b while the UE 115-b operates in the active state, a control signal including a request for the UE 115-b to transition to an inactive state for at least a time period 530 and a set of one or more communication parameters for subsequent communications after the UE 115-b operates in the inactive state for at least the time period 530. The set of one or more communication parameters may be, for example, a timing offset, a frequency offset, a beam, a BWP, a CORESET, one or more other parameters, or any combination thereof for communications by the UE 115-b in a subsequent active state.

The control signal may be, for example, a DCI message including a PDCCH skipping indication, a MAC-CE, or some other type of control signal. The inactive state may be associated with the UE 115-b skipping (e.g., refraining from) monitoring for the PDCCH. In some examples, the control signal may request the UE 115-b to transition to the inactive state of a DRX cycle earlier than the UE 115-b would make the transition based on a DRX configuration. Additionally, or alternatively, the UE 115-b may not operate in a DRX mode, and the control signal (e.g., DCI) may request the UE 115-b to transition to an inactive state for a time period 530 (e.g., to refrain from monitoring for PDCCH for the time period 530).

The network entity 105-b may indicate the set of one or more communication parameters to the UE 115-b via the control signal to reduce overhead and improve communication reliability. For example, the network entity 105-b may refrain from transmitting other additional signaling to indicate the communication parameters by including the communication parameters in the control signal. The control signal may include one or more fields or bits to indicate the communication parameters, as described in further detail elsewhere herein, including with reference to FIGS. 4A-4C. The preemptive indication of the communication parameters may provide for the UE 115-b to perform subsequent communications reliably without performing a random access procedure or blind decoding each time the UE 115-b enters an active state. For example, if one of the UE 115-b or the network entity 105-b, or both, are relatively mobile, the communication parameters may change relatively frequently (e.g., while the UE 115-b is in the inactive state). By indicating the communication parameters preemptively, the network entity 105-b may improve coordination and reliability.

At 515, the UE 115-b may transition from the active state to the inactive state for at least the time period 530 based on the control signal. That is, the UE 115-b may refrain from monitoring for a PDCCH for at least the time period 530. In some examples, the control signal may indicate the time period 530.

At 520, the UE 115-b may transition from the inactive state back to the active state. The UE 115-b may operate in the active state in accordance with the set of one or more communication parameters indicated via the control signal. In some examples, the UE 115-b may transition back to the active state after or at the same time that the time period 530 expires. Additionally, or alternatively, the UE 115-b may remain in the inactive state for a remainder of a DRX cycle, and the UE 115-b may transition back to the active state after an end of the DRX cycle (e.g., during a next active duration of the DRX cycle), which may be later than a time at which the time period 530 expires.

At 525, in some examples, the UE 115-b and the network entity 105-b may communicate in accordance with the set of one or more communication parameters. The communications may include uplink and/or downlink data or control information being exchanged between the UE 115-b and the network entity 105-b in accordance with the frequency offset, time offset, BWP, beam, CORESET, or any combination thereof indicated via the control signal. In some examples, any one or more of the communication parameters may be different than a corresponding parameter used for communications between the UE 115-b and the network entity 105-b in a previous active duration. In some examples, the UE 115-b may communicate with a different RRH or TRP, or other node of the network entity 105-b, or a beam of the network entity 105-b may have changed, or both.

The network entity 105-b may thereby preemptively indicate communication parameters to the UE 115-b. By indicating the communication parameters via the control signal, the network entity 105-b may reduce processing by the UE 115-b when the UE 115-b enters a subsequent active state, may reduce overhead, and may improve reliability of communications by the UE 115-b.

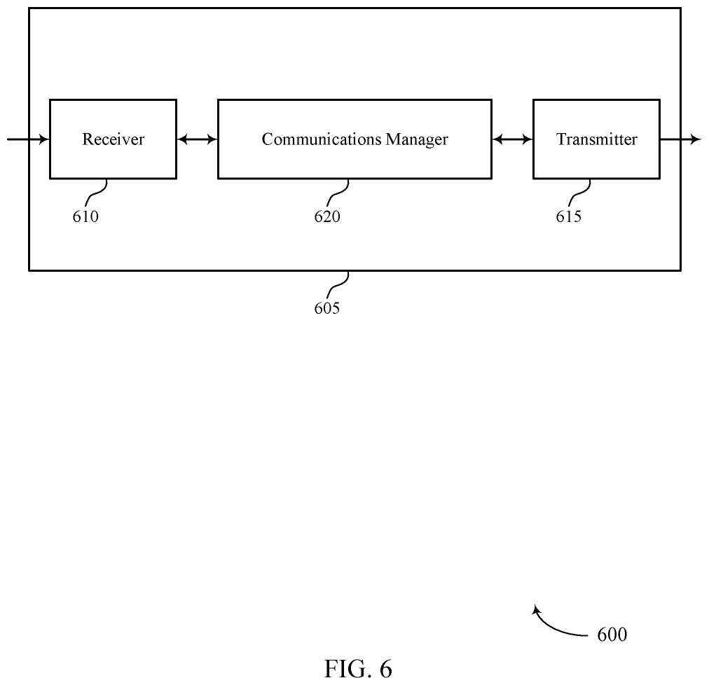

FIG. 6 shows a block diagram 600 of a device 605 that supports pre-indication for high mobility systems in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor (not shown), which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to pre-indication for high mobility systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to pre-indication for high mobility systems). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of pre-indication for high mobility systems as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel. The communications manager 620 is capable of, configured to, or operable to support a means for transitioning from the active state to the inactive state for at least the time period based on the control signal. The communications manager 620 is capable of, configured to, or operable to support a means for operating in the active state after at least the time period in accordance with the set of one or more communication parameters indicated via the control signal.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources, among other examples.

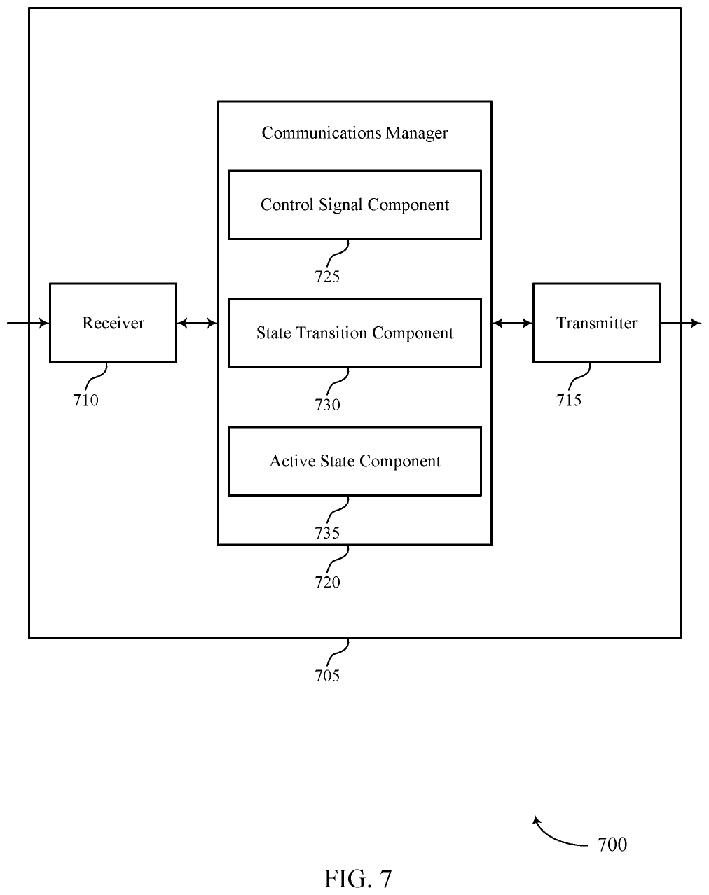

FIG. 7 shows a block diagram 700 of a device 705 that supports pre-indication for high mobility systems in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to pre-indication for high mobility systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to pre-indication for high mobility systems). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of pre-indication for high mobility systems as described herein. For example, the communications manager 720 may include a control signal component 725, a state transition component 730, an active state component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The control signal component 725 is capable of, configured to, or operable to support a means for receiving, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel. The state transition component 730 is capable of, configured to, or operable to support a means for transitioning from the active state to the inactive state for at least the time period based on the control signal. The active state component 735 is capable of, configured to, or operable to support a means for operating in the active state after at least the time period in accordance with the set of one or more communication parameters indicated via the control signal.

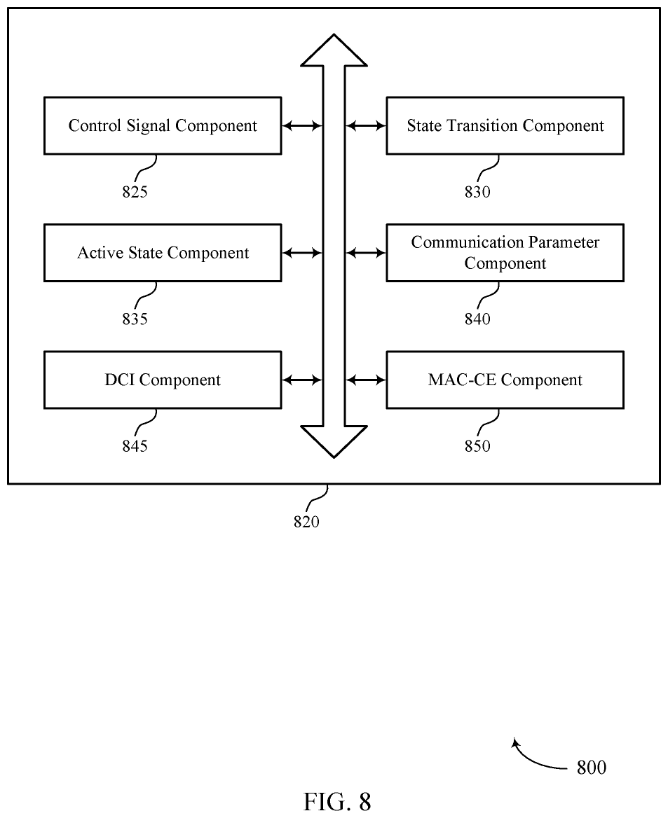

FIG. 8 shows a block diagram 800 of a communications manager 820 that supports pre-indication for high mobility systems in accordance with one or more aspects of the present disclosure. The communications manager 820 may be an example of aspects of a communications manager 620, a communications manager 720, or both, as described herein. The communications manager 820, or various components thereof, may be an example of means for performing various aspects of pre-indication for high mobility systems as described herein. For example, the communications manager 820 may include a control signal component 825, a state transition component 830, an active state component 835, a communication parameter component 840, a DCI component 845, a MAC-CE component 850, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The control signal component 825 is capable of, configured to, or operable to support a means for receiving, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel. The state transition component 830 is capable of, configured to, or operable to support a means for transitioning from the active state to the inactive state for at least the time period based on the control signal. The active state component 835 is capable of, configured to, or operable to support a means for operating in the active state after at least the time period in accordance with the set of one or more communication parameters indicated via the control signal.

In some examples, to support receiving the control signal, the communication parameter component 840 is capable of, configured to, or operable to support a means for receiving, via a first set of one or more fields included in the control signal, the set of one or more communication parameters for the subsequent communications after operating in the inactive state for at least the time period. In some examples, to support receiving the control signal, the communication parameter component 840 is capable of, configured to, or operable to support a means for receiving, via a second set of one or more fields included in the control signal, a second set of one or more communication parameters associated with a transmission that is scheduled by the control signal.

In some examples, to support receiving the control signal, the control signal component 825 is capable of, configured to, or operable to support a means for receiving, via a first field included in the control signal, one or more bits that indicate whether one or more second fields in the control signal are associated with the set of one or more communication parameters for the subsequent communications after operating in the inactive state for at least the time period or are associated with a second set of one or more communication parameters associated with a transmission that is scheduled by the control signal.

In some examples, to support receiving the control signal, the communication parameter component 840 is capable of, configured to, or operable to support a means for receiving, via one or more first fields included in the control signal, a second set of one or more communication parameters associated with a transmission scheduled by the control signal. In some examples, to support receiving the control signal, the communication parameter component 840 is capable of, configured to, or operable to support a means for receiving, via at least one second field included in the control signal, an indication that indicates a difference between the second set of one or more communication parameters and the set of one or more communication parameters for the subsequent communications after operating in the inactive state for at least the time period.

In some examples, to support receiving the control signal, the communication parameter component 840 is capable of, configured to, or operable to support a means for receiving, via one or more fields included in the control signal, a time offset, a frequency offset, a CORESET, or any combination thereof for the subsequent communications, where the set of one or more communication parameters includes the time offset, the frequency offset, the CORESET, or any combination thereof.

In some examples, to support receiving the control signal, the communication parameter component 840 is capable of, configured to, or operable to support a means for receiving the control signal including one or more fields that are repurposed to indicate the set of one or more communication parameters for the subsequent communications.

In some examples, to support operating in the active state, the active state component 835 is capable of, configured to, or operable to support a means for operating in the active state in accordance with the set of one or more communication parameters indicated via the control signal based on the control signal including a downlink control channel skipping indication.

In some examples, to support receiving the control signal, the DCI component 845 is capable of, configured to, or operable to support a means for receiving DCI including a downlink control channel skipping indication and the set of one or more communication parameters, where the downlink control channel skipping indication indicates the request for the UE to transition to the inactive state for at least the time period.

In some examples, the state transition component 830 is capable of, configured to, or operable to support a means for transitioning, based on the control signal indicating the time period, from the inactive state to the active state after the time period expires.

In some examples, to support receiving the control signal, the MAC-CE component 850 is capable of, configured to, or operable to support a means for receiving, during an active duration of a DRX cycle of the UE, a MAC-CE that includes the request for the UE to transition to the inactive state associated with an inactive duration of the DRX cycle and that includes the set of one or more communication parameters, where the UE transitions from the inactive state back to the active state after at least the time period in accordance with the DRX cycle.

In some examples, the state transition component 830 is capable of, configured to, or operable to support a means for transitioning from the inactive state to the active state after at least the time period in accordance with a DRX cycle of the UE, where the control signal is received during an active duration of the DRX cycle of the UE, and where transitioning to the active state occurs after an inactive duration of the DRX cycle of the UE expires.

In some examples, the set of one or more communication parameters includes a timing offset, a frequency offset, a beam, a BWP, a CORESET, or any combination thereof for the subsequent communications.

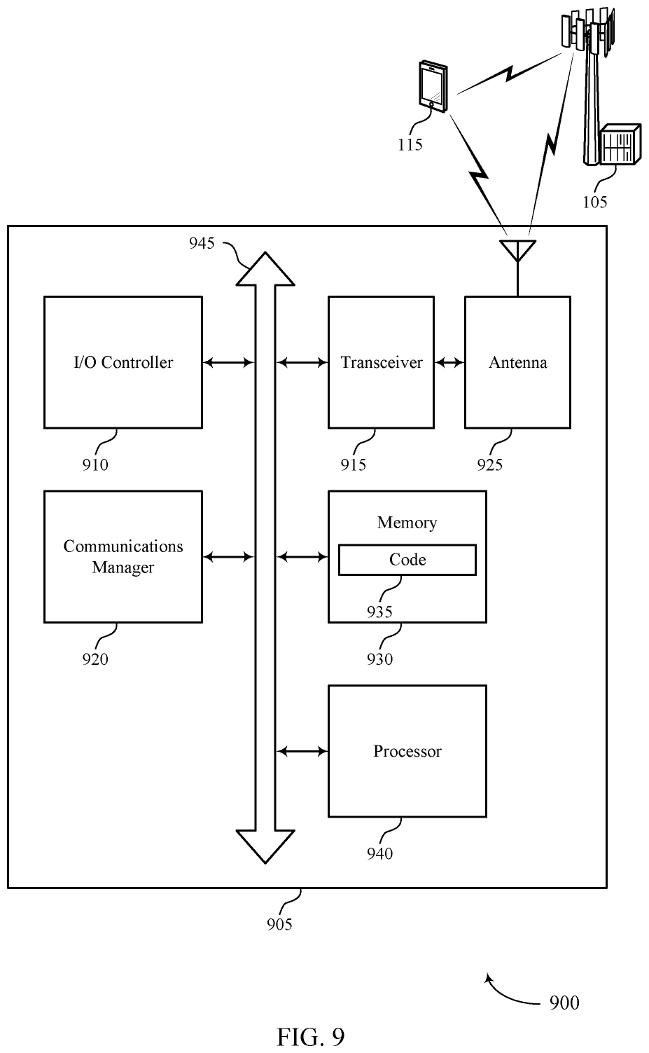

FIG. 9 shows a diagram of a system 900 including a device 905 that supports pre-indication for high mobility systems in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting pre-indication for high mobility systems). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein.

The communications manager 920 may support wireless communication in accordance with examples as disclosed herein. For example, the communications manager 920 is capable of, configured to, or operable to support a means for receiving, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel. The communications manager 920 is capable of, configured to, or operable to support a means for transitioning from the active state to the inactive state for at least the time period based on the control signal. The communications manager 920 is capable of, configured to, or operable to support a means for operating in the active state after at least the time period in accordance with the set of one or more communication parameters indicated via the control signal.

By including or configuring the communications manager 920 in accordance with examples as described herein, the device 905 may support techniques for improved communication reliability, reduced latency, improved user experience related to reduced processing, reduced power consumption, and improved coordination between devices, among other examples.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described herein with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of pre-indication for high mobility systems as described herein, or the at least one processor 940 and the at least one memory 930 may be otherwise configured to, individually or collectively, perform or support such operations.

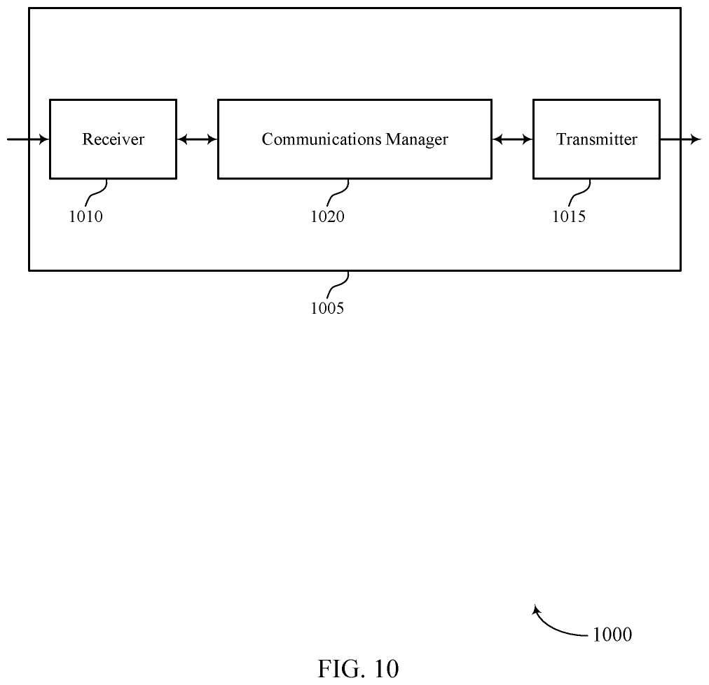

FIG. 10 shows a block diagram 1000 of a device 1005 that supports pre-indication for high mobility systems in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of pre-indication for high mobility systems as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for transmitting, to a UE that is operating in an active state, a control signal including a request for the UE to transition to an inactive state for at least a time period, the control signal including a set of one or more communication parameters for subsequent communications in the active state after the UE operates in the inactive state for at least the time period. The communications manager 1020 is capable of, configured to, or operable to support a means for transmitting, after at least the time period, a downlink communication in accordance with the set of one or more communication parameters indicated via the control signal.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources, among other examples.

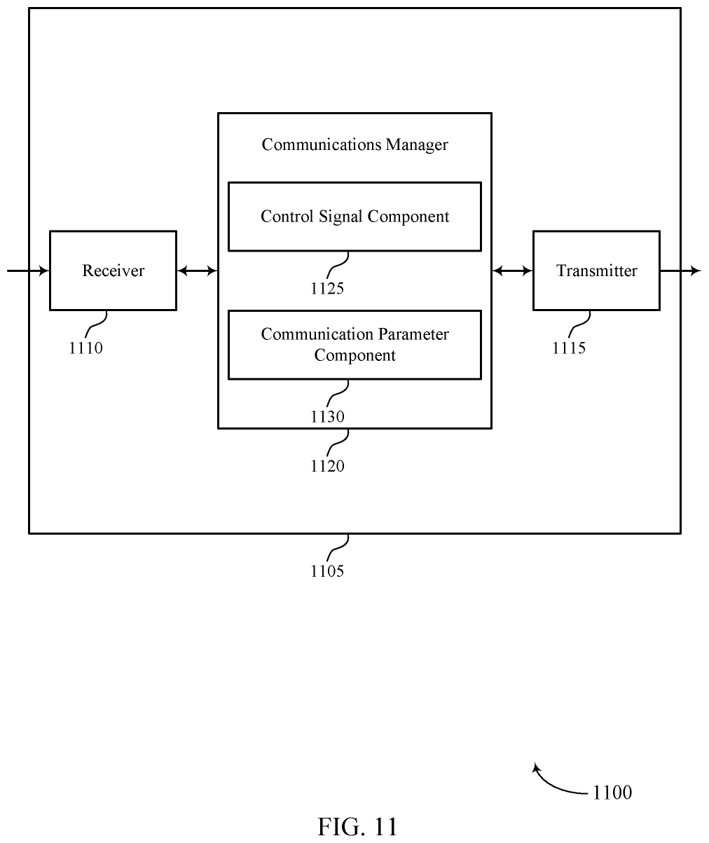

FIG. 11 shows a block diagram 1100 of a device 1105 that supports pre-indication for high mobility systems in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor (not shown), which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of pre-indication for high mobility systems as described herein. For example, the communications manager 1120 may include a control signal component 1125 a communication parameter component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The control signal component 1125 is capable of, configured to, or operable to support a means for transmitting, to a UE that is operating in an active state, a control signal including a request for the UE to transition to an inactive state for at least a time period, the control signal including a set of one or more communication parameters for subsequent communications in the active state after the UE operates in the inactive state for at least the time period. The communication parameter component 1130 is capable of, configured to, or operable to support a means for transmitting, after at least the time period, a downlink communication in accordance with the set of one or more communication parameters indicated via the control signal.

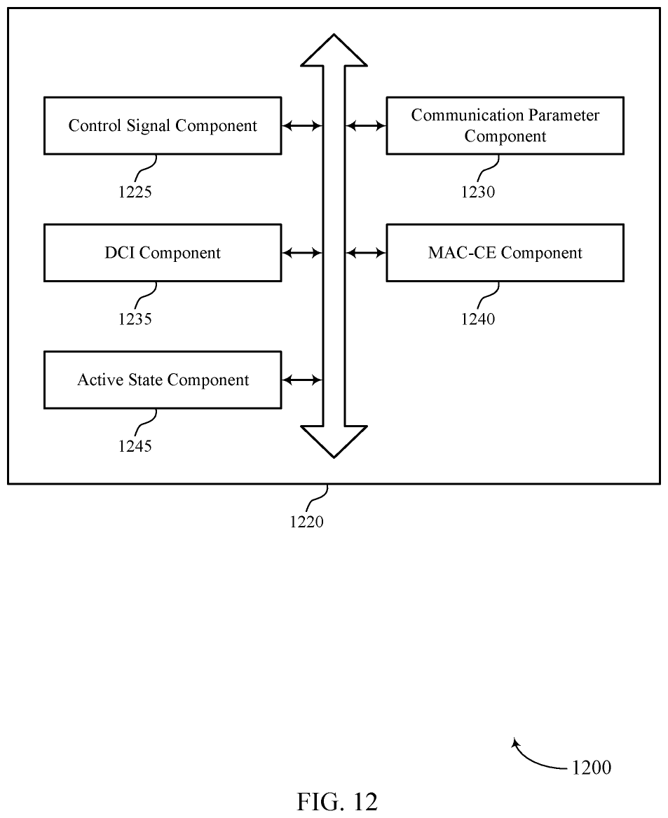

FIG. 12 shows a block diagram 1200 of a communications manager 1220 that supports pre-indication for high mobility systems in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of pre-indication for high mobility systems as described herein. For example, the communications manager 1220 may include a control signal component 1225, a communication parameter component 1230, a DCI component 1235, a MAC-CE component 1240, an active state component 1245, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The control signal component 1225 is capable of, configured to, or operable to support a means for transmitting, to a UE that is operating in an active state, a control signal including a request for the UE to transition to an inactive state for at least a time period, the control signal including a set of one or more communication parameters for subsequent communications in the active state after the UE operates in the inactive state for at least the time period. The communication parameter component 1230 is capable of, configured to, or operable to support a means for transmitting, after at least the time period, a downlink communication in accordance with the set of one or more communication parameters indicated via the control signal.

In some examples, to support transmitting the control signal, the communication parameter component 1230 is capable of, configured to, or operable to support a means for transmitting, via a first set of one or more fields included in the control signal, the set of one or more communication parameters for the subsequent communications in the active state after at least the time period. In some examples, to support transmitting the control signal, the communication parameter component 1230 is capable of, configured to, or operable to support a means for transmitting, via a second set of one or more fields included in the control signal, a second set of one or more communication parameters associated with a transmission that is scheduled by the control signal.

In some examples, to support transmitting the control signal, the control signal component 1225 is capable of, configured to, or operable to support a means for transmitting, via a first field included in the control signal, one or more bits that indicate whether one or more second fields in the control signal are associated with the set of one or more communication parameters for the subsequent communications in the active state after at least the time period or are associated with a second set of one or more communication parameters associated with a transmission that is scheduled by the control signal.

In some examples, to support transmitting the control signal, the communication parameter component 1230 is capable of, configured to, or operable to support a means for transmitting, via one or more first fields included in the control signal, a second set of one or more communication parameters associated with a transmission scheduled by the control signal. In some examples, to support transmitting the control signal, the communication parameter component 1230 is capable of, configured to, or operable to support a means for transmitting, via at least one second field included in the control signal, an indication that indicates a difference between the second set of one or more communication parameters and the set of one or more communication parameters for the subsequent communications in the active state after at least the time period.

In some examples, to support transmitting the control signal, the communication parameter component 1230 is capable of, configured to, or operable to support a means for transmitting, via one or more fields included in the control signal, a time offset, a frequency offset, a CORESET, or any combination thereof for the subsequent communications, where the set of one or more communication parameters includes the time offset, the frequency offset, the CORESET, or any combination thereof.

In some examples, to support transmitting the control signal, the communication parameter component 1230 is capable of, configured to, or operable to support a means for transmitting the control signal including one or more fields that are repurposed to indicate the set of one or more communication parameters for the subsequent communications in the active state after at least the time period.

In some examples, to support transmitting the control signal, the DCI component 1235 is capable of, configured to, or operable to support a means for transmitting DCI including a downlink control channel skipping indication and the set of one or more communication parameters, where the downlink control channel skipping indication indicates the request for the UE to transition to the inactive state for at least the time period.

In some examples, to support transmitting the control signal, the MAC-CE component 1240 is capable of, configured to, or operable to support a means for transmitting, during an active duration of a DRX cycle of the UE, a MAC-CE that includes the request for the UE to transition to the inactive state associated with an inactive duration of the DRX cycle and that includes the set of one or more communication parameters.

In some examples, to support transmitting the control signal, the active state component 1245 is capable of, configured to, or operable to support a means for transmitting the control signal during an active duration of a DRX cycle of the UE.

In some examples, the set of one or more communication parameters includes a timing offset, a frequency offset, a beam, a BWP, a CORESET, or any combination thereof for the subsequent communications.

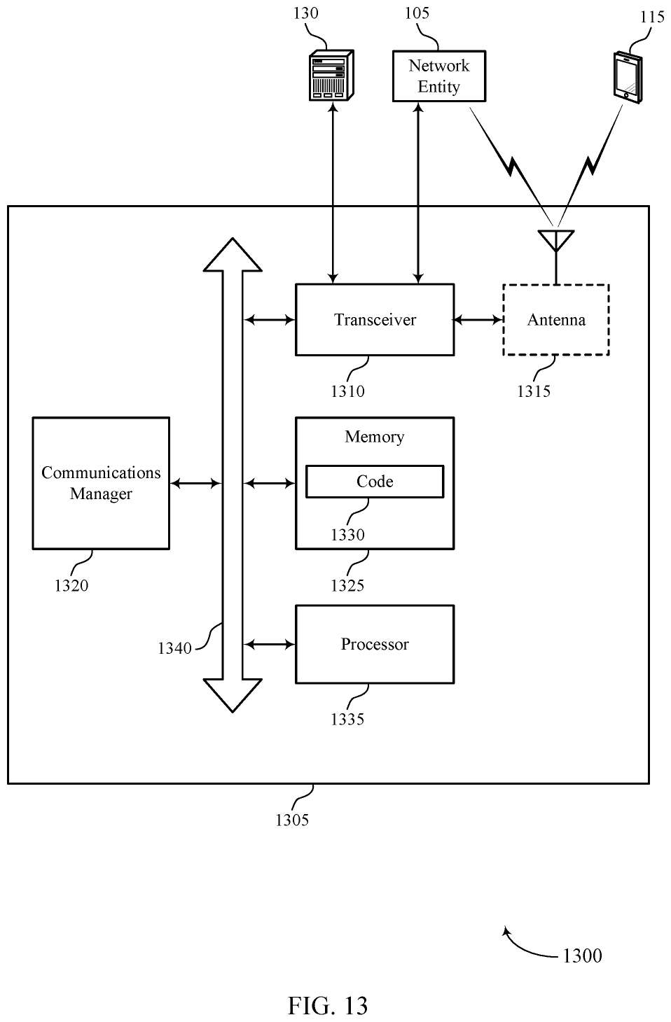

FIG. 13 shows a diagram of a system 1300 including a device 1305 that supports pre-indication for high mobility systems in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting pre-indication for high mobility systems). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some implementations, the at least one processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the at least one processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for transmitting, to a UE that is operating in an active state, a control signal including a request for the UE to transition to an inactive state for at least a time period, the control signal including a set of one or more communication parameters for subsequent communications in the active state after the UE operates in the inactive state for at least the time period. The communications manager 1320 is capable of, configured to, or operable to support a means for transmitting, after at least the time period, a downlink communication in accordance with the set of one or more communication parameters indicated via the control signal.

By including or configuring the communications manager 1320 in accordance with examples as described herein, the device 1305 may support techniques for improved communication reliability, reduced latency, reduced power consumption, more efficient utilization of communication resources, and improved coordination between devices, among other examples.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described herein with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of pre-indication for high mobility systems as described herein, or the at least one processor 1335 and the at least one memory 1325 may be otherwise configured to, individually or collectively, perform or support such operations.

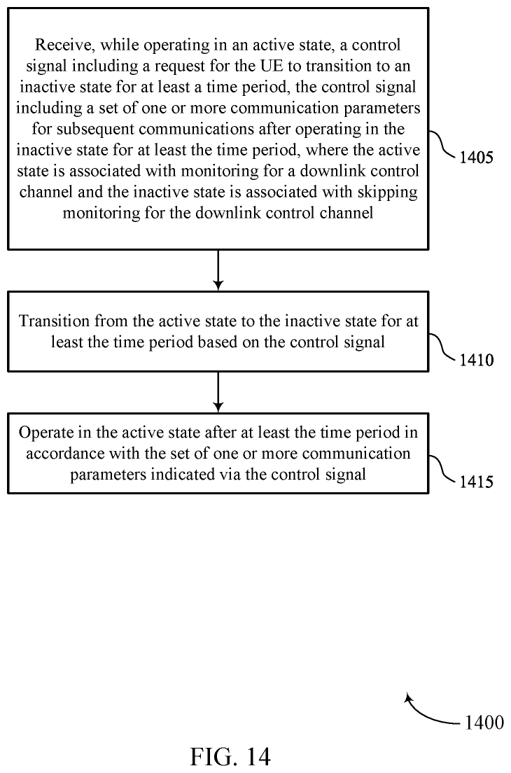

FIG. 14 shows a flowchart illustrating a method 1400 that supports pre-indication for high mobility systems in accordance with aspects of the present disclosure. The operations of the method 1400 may be implemented by a UE or its components as described herein. For example, the operations of the method 1400 may be performed by a UE 115 as described herein with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel. The operations of block 1405 may be performed in accordance with examples as disclosed herein. In some examples, aspects of the operations of 1405 may be performed by a control signal component 825 as described herein with reference to FIG. 8.

At 1410, the method may include transitioning from the active state to the inactive state for at least the time period based on the control signal. The operations of block 1410 may be performed in accordance with examples as disclosed herein. In some examples, aspects of the operations of 1410 may be performed by a state transition component 830 as described herein with reference to FIG. 8.

At 1415, the method may include operating in the active state after at least the time period in accordance with the set of one or more communication parameters indicated via the control signal. The operations of block 1415 may be performed in accordance with examples as disclosed herein. In some examples, aspects of the operations of 1415 may be performed by an active state component 835 as described herein with reference to FIG. 8.

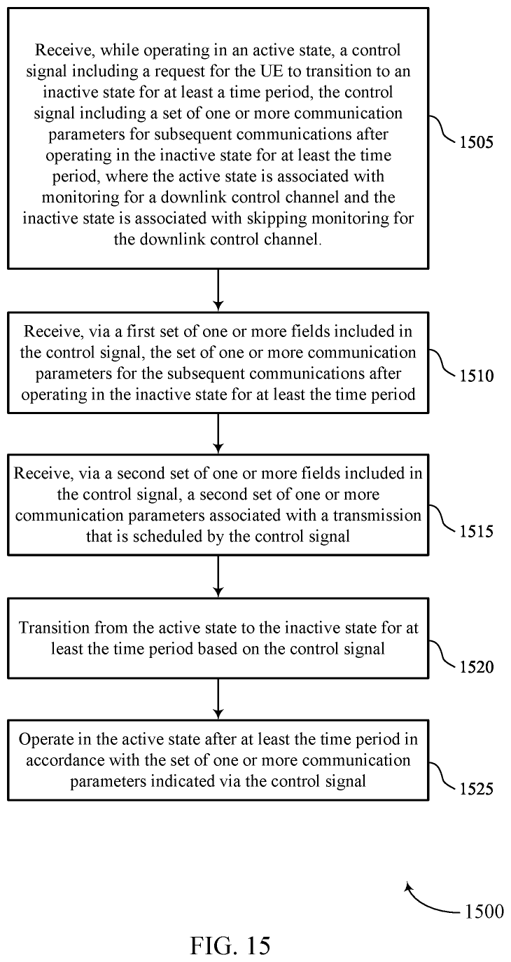

FIG. 15 shows a flowchart illustrating a method 1500 that supports pre-indication for high mobility systems in accordance with aspects of the present disclosure. The operations of the method 1500 may be implemented by a UE or its components as described herein. For example, the operations of the method 1500 may be performed by a UE 115 as described herein with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel. The operations of block 1505 may be performed in accordance with examples as disclosed herein. In some examples, aspects of the operations of 1505 may be performed by a control signal component 825 as described herein with reference to FIG. 8.

At 1510, to receive the control signal, the UE may receive, via a first set of one or more fields included in the control signal, the set of one or more communication parameters for the subsequent communications after operating in the inactive state for at least the time period. The operations of block 1510 may be performed in accordance with examples as disclosed herein. In some examples, aspects of the operations of 1510 may be performed by a communication parameter component 840 as described herein with reference to FIG. 8.

At 1515, to receive the control signal, the UE may receive, via a second set of one or more fields included in the control signal, a second set of one or more communication parameters associated with a transmission that is scheduled by the control signal. The operations of block 1515 may be performed in accordance with examples as disclosed herein. In some examples, aspects of the operations of 1515 may be performed by a communication parameter component 840 as described herein with reference to FIG. 8.

At 1520, the method may include transitioning from the active state to the inactive state for at least the time period based on the control signal. The operations of block 1520 may be performed in accordance with examples as disclosed herein. In some examples, aspects of the operations of 1520 may be performed by a state transition component 830 as described herein with reference to FIG. 8.

At 1525, the method may include operating in the active state after at least the time period in accordance with the set of one or more communication parameters indicated via the control signal. The operations of block 1525 may be performed in accordance with examples as disclosed herein. In some examples, aspects of the operations of 1525 may be performed by an active state component 835 as described herein with reference to FIG. 8.

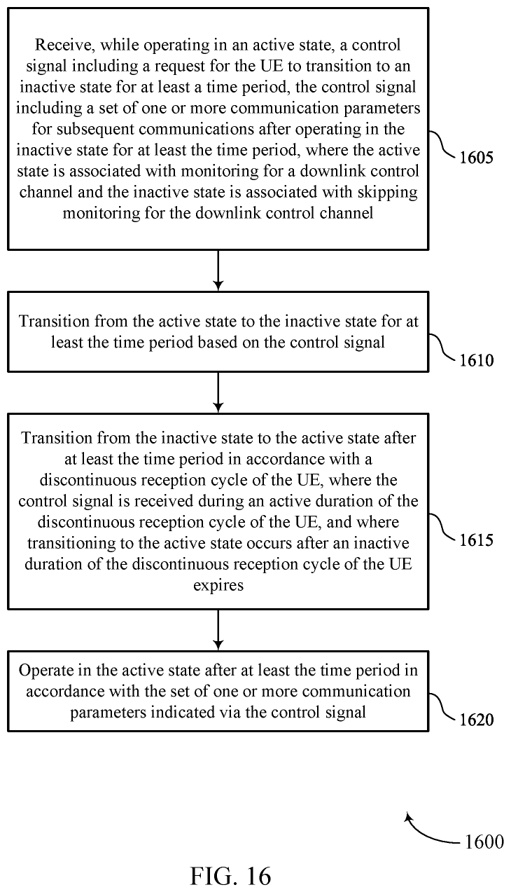

FIG. 16 shows a flowchart illustrating a method 1600 that supports pre-indication for high mobility systems in accordance with aspects of the present disclosure. The operations of the method 1600 may be implemented by a UE or its components as described herein. For example, the operations of the method 1600 may be performed by a UE 115 as described herein with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, while operating in an active state, a control signal including a request for the UE to transition to an inactive state for at least a time period, the control signal including a set of one or more communication parameters for subsequent communications after operating in the inactive state for at least the time period, where the active state is associated with monitoring for a downlink control channel and the inactive state is associated with skipping monitoring for the downlink control channel. The operations of block 1605 may be performed in accordance with examples as disclosed herein. In some examples, aspects of the operations of 1605 may be performed by a control signal component 825 as described herein with reference to FIG. 8.

At 1610, the method may include transitioning from the active state to the inactive state for at least the time period based on the control signal. The operations of block 1610 may be performed in accordance with examples as disclosed herein. In some examples, aspects of the operations of 1610 may be performed by a state transition component 830 as described herein with reference to FIG. 8.

At 1615, the method may include transitioning from the inactive state to the active state after at least the time period in accordance with a DRX cycle of the UE, where the control signal is received during an active duration of the DRX cycle of the UE, and where transitioning to the active state occurs after an inactive duration of the DRX cycle of the UE expires. The operations of block 1615 may be performed in accordance with examples as disclosed herein. In some examples, aspects of the operations of 1615 may be performed by a state transition component 830 as described herein with reference to FIG. 8.

At 1620, the method may include operating in the active state after at least the time period in accordance with the set of one or more communication parameters indicated via the control signal. The operations of block 1620 may be performed in accordance with examples as disclosed herein. In some examples, aspects of the operations of 1620 may be performed by an active state component 835 as described herein with reference to FIG. 8.

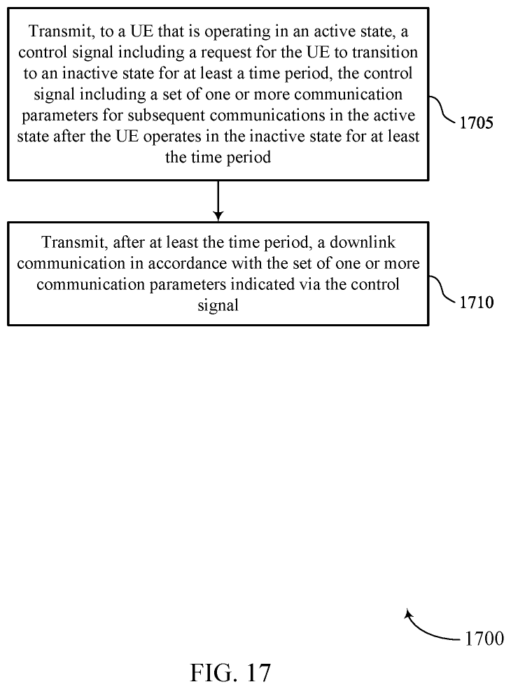

FIG. 17 shows a flowchart illustrating a method 1700 that supports pre-indication for high mobility systems in accordance with aspects of the present disclosure. The operations of the method 1700 may be implemented by a network entity or its components as described herein. For example, the operations of the method 1700 may be performed by a network entity as described herein with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE that is operating in an active state, a control signal including a request for the UE to transition to an inactive state for at least a time period, the control signal including a set of one or more communication parameters for subsequent communications in the active state after the UE operates in the inactive state for at least the time period. The operations of block 1705 may be performed in accordance with examples as disclosed herein. In some examples, aspects of the operations of 1705 may be performed by a control signal component 1225 as described herein with reference to FIG. 12.

At 1710, the method may include transmitting, after at least the time period, a downlink communication in accordance with the set of one or more communication parameters indicated via the control signal. The operations of block 1710 may be performed in accordance with examples as disclosed herein. In some examples, aspects of the operations of 1710 may be performed by a communication parameter component 1230 as described herein with reference to FIG. 12.

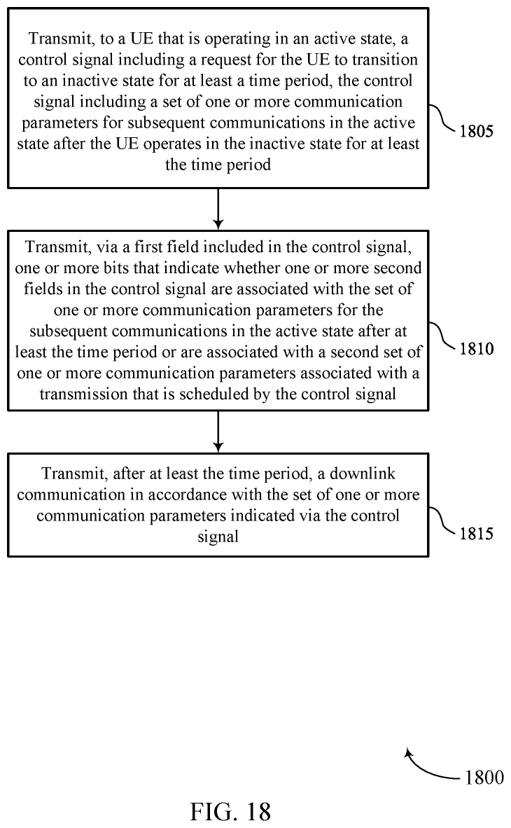

FIG. 18 shows a flowchart illustrating a method 1800 that supports pre-indication for high mobility systems in accordance with aspects of the present disclosure. The operations of the method 1800 may be implemented by a network entity or its components as described herein. For example, the operations of the method 1800 may be performed by a network entity as described herein with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE that is operating in an active state, a control signal including a request for the UE to transition to an inactive state for at least a time period, the control signal including a set of one or more communication parameters for subsequent communications in the active state after the UE operates in the inactive state for at least the time period. The operations of block 1805 may be performed in accordance with examples as disclosed herein. In some examples, aspects of the operations of 1805 may be performed by a control signal component 1225 as described herein with reference to FIG. 12.

At 1810, to transmit the control signal, the network entity may transmit, via a first field included in the control signal, one or more bits that indicate whether one or more second fields in the control signal are associated with the set of one or more communication parameters for the subsequent communications in the active state after at least the time period or are associated with a second set of one or more communication parameters associated with a transmission that is scheduled by the control signal. The operations of block 1810 may be performed in accordance with examples as disclosed herein. In some examples, aspects of the operations of 1810 may be performed by a control signal component 1225 as described herein with reference to FIG. 12.

At 1815, the method may include transmitting, after at least the time period, a downlink communication in accordance with the set of one or more communication parameters indicated via the control signal. The operations of block 1815 may be performed in accordance with examples as disclosed herein. In some examples, aspects of the operations of 1815 may be performed by a communication parameter component 1230 as described herein with reference to FIG. 12.

The following provides an overview of aspects of the present disclosure:

Aspect 1: A method for wireless communication by a UE, comprising: receiving, while operating in an active state, a control signal comprising a request for the UE to transition to an inactive state for at least a time period, the control signal comprising a set of one or more communication parameters for subsequent communications after operating in the inactive state for at least the time period, wherein the active state is associated with monitoring for a downlink control channel and the inactive state is associated with skipping monitoring for the downlink control channel; transitioning from the active state to the inactive state for at least the time period based at least in part on the control signal; and operating in the active state after at least the time period in accordance with the set of one or more communication parameters indicated via the control signal.

Aspect 2: The method of aspect 1, wherein receiving the control signal comprises: receiving, via a first set of one or more fields included in the control signal, the set of one or more communication parameters for the subsequent communications after operating in the inactive state for at least the time period; and receiving, via a second set of one or more fields included in the control signal, a second set of one or more communication parameters associated with a transmission that is scheduled by the control signal.

Aspect 3: The method of aspect 1, wherein receiving the control signal comprises: receiving, via a first field included in the control signal, one or more bits that indicate whether one or more second fields in the control signal are associated with the set of one or more communication parameters for the subsequent communications after operating in the inactive state for at least the time period or are associated with a second set of one or more communication parameters associated with a transmission that is scheduled by the control signal.

Aspect 4: The method of aspect 1, wherein receiving the control signal comprises: receiving, via one or more first fields included in the control signal, a second set of one or more communication parameters associated with a transmission scheduled by the control signal; and receiving, via at least one second field included in the control signal, an indication that indicates a difference between the second set of one or more communication parameters and the set of one or more communication parameters for the subsequent communications after operating in the inactive state for at least the time period.

Aspect 5: The method of any of aspects 1 through 4, wherein receiving the control signal comprises: receiving, via one or more fields included in the control signal, a time offset, a frequency offset, a CORESET, or any combination thereof for the subsequent communications, wherein the set of one or more communication parameters comprises the time offset, the frequency offset, the CORESET, or any combination thereof.

Aspect 6: The method of any of aspects 1 through 5, wherein receiving the control signal comprises: receiving the control signal comprising one or more fields that are repurposed to indicate the set of one or more communication parameters for the subsequent communications.

Aspect 7: The method of any of aspects 1 through 6, wherein operating in the active state comprises: operating in the active state in accordance with the set of one or more communication parameters indicated via the control signal based at least in part on the control signal comprising a downlink control channel skipping indication.

Aspect 8: The method of any of aspects 1 through 7, wherein receiving the control signal comprises: receiving DCI comprising a downlink control channel skipping indication and the set of one or more communication parameters, wherein the downlink control channel skipping indication indicates the request for the UE to transition to the inactive state for at least the time period.

Aspect 9: The method of aspect 8, further comprising: transitioning, based at least in part on the control signal indicating the time period, from the inactive state to the active state after the time period expires.

Aspect 10: The method of any of aspects 1 through 9, wherein receiving the control signal comprises: receiving, during an active duration of a DRX cycle of the UE, a MAC-CE that comprises the request for the UE to transition to the inactive state associated with an inactive duration of the DRX cycle and that comprises the set of one or more communication parameters, wherein the UE transitions from the inactive state back to the active state after at least the time period in accordance with the DRX cycle.

Aspect 11: The method of any of aspects 1 through 10, further comprising: transitioning from the inactive state to the active state after at least the time period in accordance with a DRX cycle of the UE, wherein the control signal is received during an active duration of the DRX cycle of the UE, and wherein transitioning to the active state occurs after an inactive duration of the DRX cycle of the UE expires.

Aspect 12: The method of any of aspects 1 through 11, wherein the set of one or more communication parameters comprises a timing offset, a frequency offset, a beam, a bandwidth part, a CORESET, or any combination thereof for the subsequent communications.

Aspect 13: A method for wireless communication by a network entity, comprising: transmitting, to a UE that is operating in an active state, a control signal comprising a request for the UE to transition to an inactive state for at least a time period, the control signal comprising a set of one or more communication parameters for subsequent communications in the active state after the UE operates in the inactive state for at least the time period; and transmitting, after at least the time period, a downlink communication in accordance with the set of one or more communication parameters indicated via the control signal.

Aspect 14: The method of aspect 13, wherein transmitting the control signal comprises: transmitting, via a first set of one or more fields included in the control signal, the set of one or more communication parameters for the subsequent communications in the active state after at least the time period; and transmitting, via a second set of one or more fields included in the control signal, a second set of one or more communication parameters associated with a transmission that is scheduled by the control signal.

Aspect 15: The method of aspect 13, wherein transmitting the control signal comprises: transmitting, via a first field included in the control signal, one or more bits that indicate whether one or more second fields in the control signal are associated with the set of one or more communication parameters for the subsequent communications in the active state after at least the time period or are associated with a second set of one or more communication parameters associated with a transmission that is scheduled by the control signal.

Aspect 16: The method of aspect 13, wherein transmitting the control signal comprises: transmitting, via one or more first fields included in the control signal, a second set of one or more communication parameters associated with a transmission scheduled by the control signal; and transmitting, via at least one second field included in the control signal, an indication that indicates a difference between the second set of one or more communication parameters and the set of one or more communication parameters for the subsequent communications in the active state after at least the time period.

Aspect 17: The method of any of aspects 13 through 16, wherein transmitting the control signal comprises: transmitting, via one or more fields included in the control signal, a time offset, a frequency offset, a CORESET, or any combination thereof for the subsequent communications, wherein the set of one or more communication parameters comprises the time offset, the frequency offset, the CORESET, or any combination thereof.

Aspect 18: The method of any of aspects 13 through 17, wherein transmitting the control signal comprises: transmitting the control signal comprising one or more fields that are repurposed to indicate the set of one or more communication parameters for the subsequent communications in the active state after at least the time period.

Aspect 19: The method of any of aspects 13 through 18, wherein transmitting the control signal comprises: transmitting DCI comprising a downlink control channel skipping indication and the set of one or more communication parameters, wherein the downlink control channel skipping indication indicates the request for the UE to transition to the inactive state for at least the time period.

Aspect 20: The method of any of aspects 13 through 19, wherein transmitting the control signal comprises: transmitting, during an active duration of a DRX cycle of the UE, a MAC-CE that comprises the request for the UE to transition to the inactive state associated with an inactive duration of the DRX cycle and that comprises the set of one or more communication parameters.

Aspect 21: The method of any of aspects 13 through 20, wherein transmitting the control signal comprises: transmitting the control signal during an active duration of a DRX cycle of the UE.

Aspect 22: The method of any of aspects 13 through 21, wherein the set of one or more communication parameters comprises a timing offset, a frequency offset, a beam, a bandwidth part, a CORESET, or any combination thereof for the subsequent communications.

Aspect 23: An apparatus for wireless communication at a UE, comprising at least one processor; and at least one memory coupled with the at least one processor, with instructions stored in the at least one memory, the instructions being executable by the at least one processor, individually or in any combination, to cause the apparatus to perform a method of any of aspects 1 through 12.

Aspect 24: An apparatus for wireless communication at a UE, comprising at least one means for performing a method of any of aspects 1 through 12.

Aspect 25: A non-transitory computer-readable medium storing code for wireless communication, the code comprising instructions executable by a processor to perform a method of any of aspects 1 through 12.

Aspect 26: An apparatus for wireless communication at a network entity, comprising at least one processor; and at least one memory coupled with the at least one processor, with instructions stored in the at least one memory, the instructions being executable by the at least one processor, individually or in any combination, to cause the apparatus to perform a method of any of aspects 13 through 22.

Aspect 27: An apparatus for wireless communication at a network entity, comprising at least one means for performing a method of any of aspects 13 through 22.

Aspect 28: A non-transitory computer-readable medium storing code for wireless communication, the code comprising instructions executable by a processor to perform a method of any of aspects 13 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
at least one memory coupled with the at least one processor, with instructions stored in the at least one memory, the instructions being executable by the at least one processor, individually or in any combination, to cause the apparatus to:
receive, while operating in an active state, a control signal comprising a request for the UE to transition to an inactive state for at least a time period, the control signal comprising a set of one or more communication parameters for subsequent communications after operating in the inactive state for at least the time period, wherein the active state is associated with monitoring for a downlink control channel and the inactive state is associated with skipping monitoring for the downlink control channel;
transition from the active state to the inactive state for at least the time period based at least in part on the control signal; and
operate in the active state after at least the time period in accordance with the set of one or more communication parameters indicated via the control signal.

2. The apparatus of claim 1, wherein the instructions to receive the control signal are executable by the at least one processor, individually or in any combination, to cause the apparatus to:
receive, via a first set of one or more fields included in the control signal, the set of one or more communication parameters for the subsequent communications after operating in the inactive state for at least the time period; and
receive, via a second set of one or more fields included in the control signal, a second set of one or more communication parameters associated with a transmission that is scheduled by the control signal.

3. The apparatus of claim 1, wherein the instructions to receive the control signal are executable by the at least one processor, individually or in any combination, to cause the apparatus to:
receive, via a first field included in the control signal, one or more bits that indicate whether one or more second fields in the control signal are associated with the set of one or more communication parameters for the subsequent communications after operating in the inactive state for at least the time period or are associated with a second set of one or more communication parameters associated with a transmission that is scheduled by the control signal.

4. The apparatus of claim 1, wherein the instructions to receive the control signal are executable by the at least one processor, individually or in any combination, to cause the apparatus to:
receive, via one or more first fields included in the control signal, a second set of one or more communication parameters associated with a transmission scheduled by the control signal; and
receive, via at least one second field included in the control signal, an indication that indicates a difference between the second set of one or more communication parameters and the set of one or more communication parameters for the subsequent communications after operating in the inactive state for at least the time period.

5. The apparatus of claim 1, wherein the instructions to receive the control signal are executable by the at least one processor, individually or in any combination, to cause the apparatus to:
receive, via one or more fields included in the control signal, a time offset, a frequency offset, a control resource set, or any combination thereof for the subsequent communications, wherein the set of one or more communication parameters comprises the time offset, the frequency offset, the control resource set, or any combination thereof.

6. The apparatus of claim 1, wherein the instructions to receive the control signal are executable by the at least one processor, individually or in any combination, to cause the apparatus to:
receive the control signal comprising one or more fields that are repurposed to indicate the set of one or more communication parameters for the subsequent communications.

7. The apparatus of claim 1, wherein the instructions to operate in the active state are executable by the at least one processor, individually or in any combination, to cause the apparatus to:
operate in the active state in accordance with the set of one or more communication parameters indicated via the control signal based at least in part on the control signal comprising a downlink control channel skipping indication.

8. The apparatus of claim 1, wherein the instructions to receive the control signal are executable by the at least one processor, individually or in any combination, to cause the apparatus to:
receive downlink control information comprising a downlink control channel skipping indication and the set of one or more communication parameters, wherein the downlink control channel skipping indication indicates the request for the UE to transition to the inactive state for at least the time period.

9. The apparatus of claim 8, wherein the instructions are further executable by the at least one processor, individually or in any combination, to cause the apparatus to:
transition, based at least in part on the control signal indicating the time period, from the inactive state to the active state after the time period expires.

10. The apparatus of claim 1, wherein the instructions to receive the control signal are executable by the at least one processor, individually or in any combination, to cause the apparatus to:
receive, during an active duration of a discontinuous reception cycle of the UE, a medium access control-control element that comprises the request for the UE to transition to the inactive state associated with an inactive duration of the discontinuous reception cycle and that comprises the set of one or more communication parameters, wherein the UE transitions from the inactive state back to the active state after at least the time period in accordance with the discontinuous reception cycle.

11. The apparatus of claim 1, wherein the instructions are further executable by the at least one processor, individually or in any combination, to cause the apparatus to:
transition from the inactive state to the active state after at least the time period in accordance with a discontinuous reception cycle of the UE, wherein the control signal is received during an active duration of the discontinuous reception cycle of the UE, and wherein transitioning to the active state occurs after an inactive duration of the discontinuous reception cycle of the UE expires.

12. The apparatus of claim 1, wherein the set of one or more communication parameters comprises a timing offset, a frequency offset, a beam, a bandwidth part, a control resource set, or any combination thereof for the subsequent communications.

13. An apparatus for wireless communication at a network entity, comprising:
at least one processor; and
at least one memory coupled with the at least one processor, with instructions stored in the at least one memory, the instructions being executable by the at least one processor, individually or in any combination, to cause the apparatus to:
transmit, to a user equipment (UE) that is operating in an active state, a control signal comprising a request for the UE to transition to an inactive state for at least a time period, the control signal comprising a set of one or more communication parameters for subsequent communications in the active state after the UE operates in the inactive state for at least the time period; and
transmit, after at least the time period, a downlink communication in accordance with the set of one or more communication parameters indicated via the control signal.

14. The apparatus of claim 13, wherein the instructions to transmit the control signal are executable by the at least one processor, individually or in any combination, to cause the apparatus to:
transmit, via a first set of one or more fields included in the control signal, the set of one or more communication parameters for the subsequent communications in the active state after at least the time period; and
transmit, via a second set of one or more fields included in the control signal, a second set of one or more communication parameters associated with a transmission that is scheduled by the control signal.

15. The apparatus of claim 13, wherein the instructions to transmit the control signal are executable by the at least one processor, individually or in any combination, to cause the apparatus to:
transmit, via a first field included in the control signal, one or more bits that indicate whether one or more second fields in the control signal are associated with the set of one or more communication parameters for the subsequent communications in the active state after at least the time period or are associated with a second set of one or more communication parameters associated with a transmission that is scheduled by the control signal.

16. The apparatus of claim 13, wherein the instructions to transmit the control signal are executable by the at least one processor, individually or in any combination, to cause the apparatus to:
transmit, via one or more first fields included in the control signal, a second set of one or more communication parameters associated with a transmission scheduled by the control signal; and
transmit, via at least one second field included in the control signal, an indication that indicates a difference between the second set of one or more communication parameters and the set of one or more communication parameters for the subsequent communications in the active state after at least the time period.

17. The apparatus of claim 13, wherein the instructions to transmit the control signal are executable by the at least one processor, individually or in any combination, to cause the apparatus to:
transmit, via one or more fields included in the control signal, a time offset, a frequency offset, a control resource set, or any combination thereof for the subsequent communications, wherein the set of one or more communication parameters comprises the time offset, the frequency offset, the control resource set, or any combination thereof.

18. The apparatus of claim 13, wherein the instructions to transmit the control signal are executable by the at least one processor, individually or in any combination, to cause the apparatus to:
transmit the control signal comprising one or more fields that are repurposed to indicate the set of one or more communication parameters for the subsequent communications in the active state after at least the time period.

19. The apparatus of claim 13, wherein the instructions to transmit the control signal are executable by the at least one processor, individually or in any combination, to cause the apparatus to:
transmit downlink control information comprising a downlink control channel skipping indication and the set of one or more communication parameters, wherein the downlink control channel skipping indication indicates the request for the UE to transition to the inactive state for at least the time period.

20. The apparatus of claim 13, wherein the instructions to transmit the control signal are executable by the at least one processor, individually or in any combination, to cause the apparatus to:
transmit, during an active duration of a discontinuous reception cycle of the UE, a medium access control-control element that comprises the request for the UE to transition to the inactive state associated with an inactive duration of the discontinuous reception cycle and that comprises the set of one or more communication parameters.

21. The apparatus of claim 13, wherein the instructions to transmit the control signal are executable by the at least one processor, individually or in any combination, to cause the apparatus to:
transmit the control signal during an active duration of a discontinuous reception cycle of the UE.

22. The apparatus of claim 13, wherein the set of one or more communication parameters comprises a timing offset, a frequency offset, a beam, a bandwidth part, a control resource set, or any combination thereof for the subsequent communications.

23. A method for wireless communication by a user equipment (UE), comprising:
receiving, while operating in an active state, a control signal comprising a request for the UE to transition to an inactive state for at least a time period, the control signal comprising a set of one or more communication parameters for subsequent communications after operating in the inactive state for at least the time period, wherein the active state is associated with monitoring for a downlink control channel and the inactive state is associated with skipping monitoring for the downlink control channel;
transitioning from the active state to the inactive state for at least the time period based at least in part on the control signal; and
operating in the active state after at least the time period in accordance with the set of one or more communication parameters indicated via the control signal.

24. The method of claim 23, wherein receiving the control signal comprises:
receiving, via a first set of one or more fields included in the control signal, the set of one or more communication parameters for the subsequent communications after operating in the inactive state for at least the time period; and
receiving, via a second set of one or more fields included in the control signal, a second set of one or more communication parameters associated with a transmission that is scheduled by the control signal.

25. The method of claim 23, wherein receiving the control signal comprises:
receiving, via a first field included in the control signal, one or more bits that indicate whether one or more second fields in the control signal are associated with the set of one or more communication parameters for the subsequent communications after operating in the inactive state for at least the time period or are associated with a second set of one or more communication parameters associated with a transmission that is scheduled by the control signal.

26. The method of claim 23, wherein receiving the control signal comprises:
receiving, via one or more first fields included in the control signal, a second set of one or more communication parameters associated with a transmission scheduled by the control signal; and
receiving, via at least one second field included in the control signal, an indication that indicates a difference between the second set of one or more communication parameters and the set of one or more communication parameters for the subsequent communications after operating in the inactive state for at least the time period.

27. The method of claim 23, wherein receiving the control signal comprises:
receiving, via one or more fields included in the control signal, a time offset, a frequency offset, a control resource set, or any combination thereof for the subsequent communications, wherein the set of one or more communication parameters comprises the time offset, the frequency offset, the control resource set, or any combination thereof.

28. A method for wireless communication by a network entity, comprising:
transmitting, to a user equipment (UE) that is operating in an active state, a control signal comprising a request for the UE to transition to an inactive state for at least a time period, the control signal comprising a set of one or more communication parameters for subsequent communications in the active state after the UE operates in the inactive state for at least the time period; and
transmitting, after at least the time period, a downlink communication in accordance with the set of one or more communication parameters indicated via the control signal.

29. The method of claim 28, wherein transmitting the control signal comprises:
transmitting, via a first set of one or more fields included in the control signal, the set of one or more communication parameters for the subsequent communications in the active state after at least the time period; and
transmitting, via a second set of one or more fields included in the control signal, a second set of one or more communication parameters associated with a transmission that is scheduled by the control signal.

30. The method of claim 28, wherein transmitting the control signal comprises:
transmitting, via a first field included in the control signal, one or more bits that indicate whether one or more second fields in the control signal are associated with the set of one or more communication parameters for the subsequent communications in the active state after at least the time period or are associated with a second set of one or more communication parameters associated with a transmission that is scheduled by the control signal.
